(19) United States
(12) Patent Application Publication
(10) Pub. No.: US 2014/0194140 A1
(43) Pub. Date: Jul. 10, 2014

(54) COMMUNICATION TERMINAL, POSITION MANAGEMENT SYSTEM, AND COMMUNICATION METHOD

(71) Applicant: Satoshi TAKANO, Tokyo (JP)

(72) Inventor: Satoshi TAKANO, Tokyo (JP)

(73) Assignee: RICOH COMPANY, LTD., Tokyo (JP)

(21) Appl. No.: 14/108,461

(22) Filed: Dec. 17, 2013

(30) Foreign Application Priority Data
Jan. 8, 2013 (JP) 2013-001158

(51) Int. Cl. H04W 4/02

(52) U.S. Cl. CPC H04W 4/027
USPC 455/456.1

(57) ABSTRACT

A communication terminal includes a receiving unit configured to receive position information that has been transmitted from a transmission device for transmitting predetermined position information; a detecting unit configured to detect a change in an acceleration applied to the communication terminal; a movement detecting unit configured to detect a movement of the communication terminal based on the position information and information expressing the change in the acceleration; and a sending unit configured to send the position information to the transmission device, when the movement is detected.

### BACKGROUND OF THE INVENTION

1. Field of the Invention

The present invention relates to a communication terminal, a position management system, and a communication method.

2. Description of the Related Art

Conventionally, the position of a communication terminal of a user is identified by using GPS (Global Positioning System). In GPS, radio signals indicating the time, are sent from nearly thirty GPS satellites orbiting around the earth. A communication terminal on the ground having a GPS receiver, receives the radio signals, and calculates the distance between the communication terminal and the GPS satellite, based on the difference between the time when the radio signal is sent from the GPS satellite and the time when the radio signal is received at the communication terminal. The communication terminal performs this calculation for at least four GPS satellites, and identifies the position on the ground based on the calculation results.

Furthermore, in recent years, the GPS receiver has a compact size and has a power-saving structure. Thus, GPS receivers are built in compact communication terminals driven by batteries, such as mobile phones.

However, it is difficult for GPS radio signals to reach communication terminals located indoors. Therefore, for positioning indoor locations, a mechanism other than GPS is required. As one example of another mechanism, in recent years, IMES (Indoor MEssaging System) is garnering attention.

A transmission device, which transmits radio signals by using IMES, can transmit radio signals of the same radio wave format as that of a GPS satellite. This is advantageous in that at the communication terminal receiving the radio signals, the same hardware used for receiving signals can be used, and only the software for receiving signals needs to be slightly adjusted, in order to receive radio signals from such a transmission device. Moreover, as the radio signals being sent, position information indicating the position of the transmission device using IMES is transmitted instead of time information indicating the time. Therefore, the communication terminal on the receiving side can directly receive the position information, which is advantageous in that there is no need to perform complex calculations for obtaining the difference in the time as in the case of outdoor locations.

Furthermore, a position management method using IMES is also disclosed (see Patent Document 1). In this method, after receiving position information from a transmission device using IMES disposed on an indoor ceiling, the communication terminal sends position information and the terminal ID of the communication terminal to an access point of radio LAN based on a communication standard of IEEE802.11x, and the access point transfers the position information and the terminal ID to the management server, so that the management server can manage the position of the communication terminal.

As described above, it is assumed that the communication terminal is driven in a stand-alone manner (battery-driven), regardless of the location of the power receptacle. In this case, in order to manage the position information of the communication terminal, the communication terminal sends the position information received from the transmission device using IMES, to a server managing the position information. However, in order to send the position information by communication, a large amount of power is required. Therefore, if such communication is frequently performed, it would be necessary to frequently replace or charge the battery of the communication terminal. When there are many communication terminals that are used for each management object, a heavy load is inflicted on the administrator to replace/charge batteries.
Patent Document 1: Japanese Laid-Open Patent Publication No. 2011-145873

### SUMMARY OF THE INVENTION

The present invention provides a communication terminal, a position management system, and a communication method, in which one or more of the above-described disadvantages are eliminated.

According to an aspect of the present invention, there is provided a communication terminal including a receiving unit configured to receive position information that has been transmitted from a transmission device for transmitting predetermined position information; a detecting unit configured to detect a change in an acceleration applied to the communication terminal; a movement detecting unit configured to detect a movement of the communication terminal based on the position information and information expressing the change in the acceleration; and a sending unit configured to send the position information to the transmission device, when the movement is detected.

According to an aspect of the present invention, there is provided a position management system including a communication terminal; and a position information management system, wherein the communication terminal includes a receiving unit configured to receive position information that has been transmitted from a transmission device for transmitting predetermined position information, a detecting unit configured to detect a change in an acceleration of the communication terminal, a movement detecting unit configured to detect a movement of the communication terminal based on the position information and information expressing the change in the acceleration, and a sending unit configured to send the position information to the transmission device, when the movement is detected, wherein the position information management system is configured to communicate with the communication terminal via a gateway, and to manage the position information sent from the sending unit of the communication terminal.

According to an aspect of the present invention, there is provided a communication method executed by a communication terminal, the communication method including receiving position information that has been transmitted from a transmission device for transmitting predetermined position information; detecting a change in an acceleration applied to the communication terminal; detecting a movement of the communication terminal based on the position information and information expressing the change in the acceleration; and sending the position information to the transmission device, when the movement is detected.

### BRIEF DESCRIPTION OF THE DRAWINGS

Other objects, features and advantages of the present invention will become more apparent from the following detailed description when read in conjunction with the accompanying drawings, in which:

FIG. 1 is an overall schematic diagram of a position management system according to an embodiment of the present invention;

FIG. 2 is an external view of an electrical device when the electrical device is a fluorescent light type LED light device;

FIG. 3 is a pictorial diagram illustrating the state where a communication terminal is provided on a management object;

FIG. 4 illustrates a hardware configuration of a device main body when the electrical device is an LED light device;

FIG. 5 illustrates a hardware configuration of a fluorescent light type LED lamp when the electrical device is an LED light device;

FIG. 6 is a conceptual diagram of position information that is transmitted by a transmission device;

FIG. 7 is a hardware configuration diagram of the communication terminal;

FIG. 8 is a conceptual diagram of the format of data of the position information;

FIG. 9 is a conceptual diagram illustrating a data structure of data including the position information;

FIG. 10 is a hardware configuration diagram in a case where the management object is a mobile phone;

FIG. 11 illustrates a hardware configuration of a gateway;

FIG. 12 illustrates a hardware configuration of a position information management system;

FIG. 13 is a conceptual diagram of management information managed by the position information management system;

FIG. 14 is a functional block diagram of the transmission device and the communication terminal;

FIG. 15 is a functional block diagram in a case where the management object is a mobile phone or a personal computer;

FIG. 16 is a functional block diagram of the gateway and the position information management system;

FIG. 17 is a sequence diagram indicating a process of constructing a communication network on the ceiling;

FIG. 18 is a sequence diagram illustrating a process of transmitting position information;

FIG. 19 is a sequence diagram illustrating a process of determining the position information to be used by the communication terminal, and determining the transmission device to be the transmission destination of the position information;

FIG. 20 is a flowchart of a process performed from when the communication terminal receives position information to when the communication terminal stores the position information;

FIG. 21 is a pictorial diagram indicating the communication status between the transmission device and the communication terminal;

FIG. 22 is a flowchart indicating a process of determining the transmission destination;

FIG. 23 is a sequence diagram illustrating a process of managing position information;

FIG. 24 illustrates a screen example in the position information management system;

FIG. 25 illustrates a screen example in the position information management system;

FIG. 26 is a functional block diagram of the transmission device and the communication terminal;

FIG. 27 is a functional block diagram of the gateway and the position information management system;

FIG. 28 is a conception diagram of management information managed by the position information management system;

FIG. 29 is a conception diagram of management information managed by the position information management system;

FIG. 30 is a sequence diagram illustrating a process of managing position information;

FIG. 31 is a flowchart illustrating a process of sending position information after moving; and

FIG. 32 is a flowchart illustrating a process in a case where position information expressing a particular position is received.

### DETAILED DESCRIPTION OF THE PREFERRED EMBODIMENTS

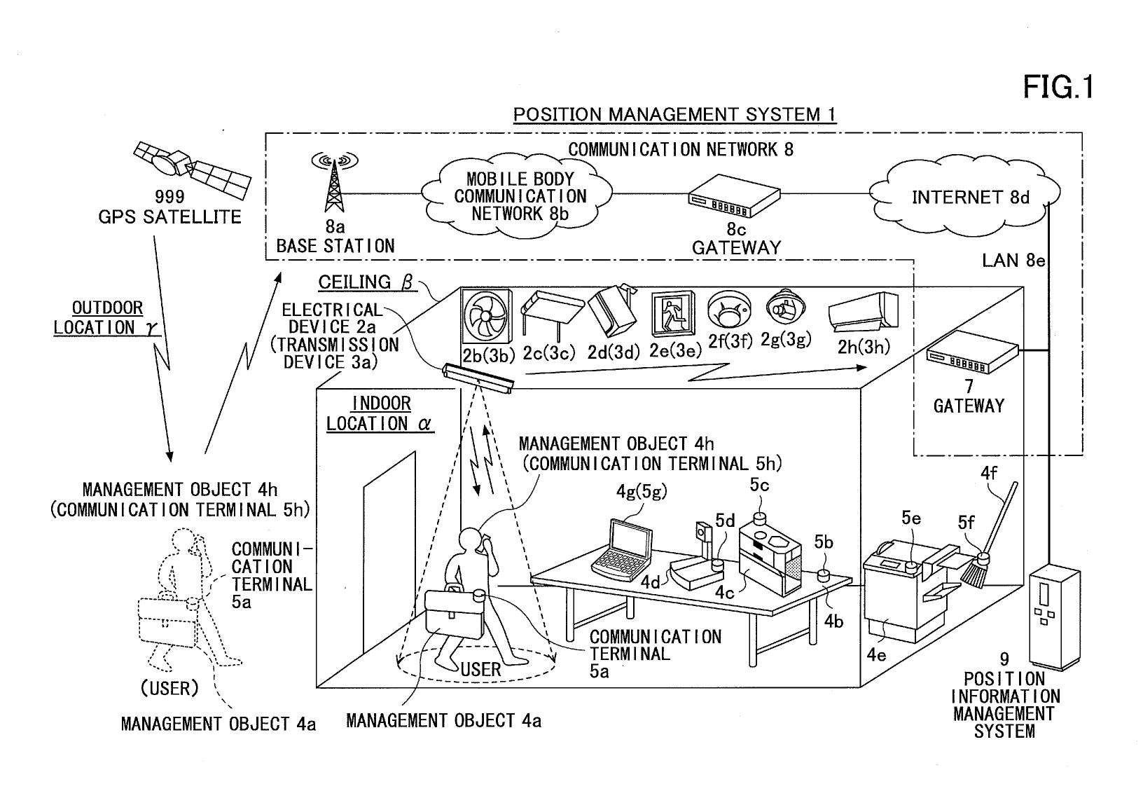

A description is given, with reference to FIGS. 1 through 25, of a position information management system according to an embodiment of the present invention.

### Description of Position Information Management System According to Embodiment of Present Invention

First, with reference to FIG. 1, a description is given of the overview of the position information management system. Note that FIG. 1 is an overall schematic diagram of a position management system.

As illustrated in FIG. 1, a position management system 1 is constructed by a plurality of transmission devices (3a, 3b, 3c, 3d, 3e, 3f, 3g, 3h) on a ceiling β of an indoor location α, a plurality of communication terminals (5a, 5b, 5c, 5d, 5e, 5f, 5g, 5h) on the floor of the indoor location α, and a position information management system 9.

Furthermore, each of the transmission devices (3a, 3b, 3c, 3d, 3e, 3f, 3g, 3h) stores position information (Xa, Xb, Xc, Xd, Xe, Xf, Xg, Xh) indicating the position where the transmission device is to be installed (meaning “position where the transmission device has been installed” after the transmission device is installed), and transmits the position information (Xa, Xb, Xc, Xd, Xe, Xf, Xg, Xh) toward the floor of the indoor location α.

Furthermore, each of the transmission devices (3a, 3b, 3c, 3d, 3e, 3f, 3g, 3h) stores device identification information (Ba, Bb, Bc, Bd, Be, Bf, Bg, Bh) for identifying each transmission device.

Note that in the following, an arbitrary transmission device among the plurality of transmission devices is referred to as a “transmission device 3”, and an arbitrary communication terminal among the plurality of communication terminals is referred to as a “communication terminal 5”. Furthermore, an arbitrary position information item among the plurality of position information items is referred to as “position information X”, and an arbitrary device identification information item among a plurality of device identification information items is referred to as “device identification information B”. An example of the device identification information B is a MAC (Media Access Control) address.

Meanwhile, each of the communication terminals (5a, 5b, 5c, 5d, 5e, 5f, 5g, 5h) stores terminal identification information (Aa, Ab, Ac, Ad, Ae, Af, Ag, Ah) for identifying each communication terminal. Note that an arbitrary terminal identification information item among the plurality of terminal identification information items is referred to as “terminal identification information A”. An example of the terminal identification information A is a MAC address. When each communication terminal 5 receives position information X from the transmission device 3, the communication terminal 5 sends the position information X together with the terminal identification information A of the self-device (the terminal itself), to the transmission device 3.

Furthermore, each of the transmission devices 3 are built in or externally attached to electrical devices (2a, 2b, 2c, 2d, 2e, 2f, 2g, 2h), which are provided on the ceiling β of the indoor location α. Note that in the following, an arbitrary electrical device among the plurality of electrical devices is referred to as an “electrical device 2”.

Each electrical device 2 supplies power to the corresponding transmission device 3. Among the electrical devices 2, the electrical device 2a is a fluorescent light type LED (Light Emitting Diode) light device. The electrical device 2b is a ventilation fan. The electrical device 2c is an access point of a radio LAN (Local Area Network). The electrical device 2d is a speaker. The electrical device 2e is an emergency light. The electrical device 2f is a fire alarm or a smoke alarm. The electrical device 2g is a monitor camera. The electrical device 2h is an air conditioner.

Note that the electrical device 2 may be an electrical device other than those illustrated in FIG. 1, as long as the electrical device can supply power to the transmission device 3. For example, other than the examples of the electrical devices 2 described above, the electrical device 2 may be a typical fluorescent lamp or an incandescent lamp other than LED, or a crime-prevention sensor for detecting an intruder from outside.

Meanwhile, each communication terminal 5 is attached to the outside of management objects (4a, 4b, 4c, 4d, 4e) whose positions are managed by the position information management system 9.

Among these management objects, the management object 4a is a bag. The management object 4b is a table. The management object 4c is a projector. The management object 4d is a TV conference terminal. The management object 4e is a MFP (multifunction product) having a copy function. The management object 4f is a broom.

Furthermore, the management object 4g is a personal computer, and the function of a communication terminal 5 is installed inside the personal computer, and therefore in this case the management object 4g is also the communication terminal 5g. Furthermore, the management object 4h is a mobile phone such as a smartphone, and the function of a communication terminal 5 is installed inside the mobile phone, and therefore in this case the management object 4h is also the communication terminal 5h. Note that in the following, an arbitrary management object among the plurality of management objects is referred to as a “management object 4”.

Furthermore, the management object 4 may be a management object other than those illustrated in FIG. 1. Other examples of the management object 4 are a fax machine, a scanner, a printer, a copier, an electronic blackboard, an air cleaning device, a shredder, a vending machine, a wrist watch, a camera, a game device, a wheelchair, and medical equipment such as an endoscope.

Next, a description is given of the overview of an example of a method of managing position information using the position management system 1. In the present embodiment, for example, the transmission device 3a provided on the ceiling β of the indoor location α transmits, by radio communication, the position information Xa indicating the position where the transmission device 3a is provided. Accordingly, the communication terminal 5a receives the position information Xa. Next, the communication terminal 5a sends, to the transmission device 3a by radio communication, the terminal identification information Aa for identifying the communication terminal 5a and the position information Xa. In this case, the communication terminal 5a returns the position information Xa received from the transmission device 3a, to the transmission device 3a.

Accordingly, the transmission device 3a receives the terminal identification information Aa and the position information Xa. Next, the transmission device 3a sends, to a gateway 7 by radio communication, the terminal identification information Aa and the position information Xa. Then, the gateway 7 sends the terminal identification information Aa and the position information Xa to the position information management system 9 via the LAN 8e. In the position information management system 9, by managing the terminal identification information Aa and the position information Xa, the administrator of the position information management system 9 can recognize the position of the communication terminal 5a (management object 4a) in the indoor location α.

Furthermore, as illustrated in FIG. 1, in an outdoor location γ, among the communication terminals 5, particularly the communication terminals (5a, 5h) can calculate the position on the earth by receiving radio signals (time information, orbit information, etc.) from a GPS (Global Positioning System) satellite 999. Then, the communication terminals (5a, 5h) can use a mobile communication system of 3G (3rd generation), 4G (4th generation), etc., to send, to the position information management system 9, the terminal identification information (Aa, Ah) for identifying the communication terminals (5a, 5h) and position information (Xa, Xh), via a base station 8a, a mobile body communication network 8b, a gateway 8c, the Internet 8d, and the LAN 8e.

Note that a communication network 8 is constituted by the base station 8a, the mobile body communication network 8b, the gateway 8c, the Internet 8d, the LAN 8e, and the gateway 7. Furthermore, in order to position the latitude and the longitude on the earth, at least three GPS satellites are necessary (four GPS satellites are necessary if the height is included); however, as a matter of simplification, only one GPS satellite is illustrated in FIG. 1.

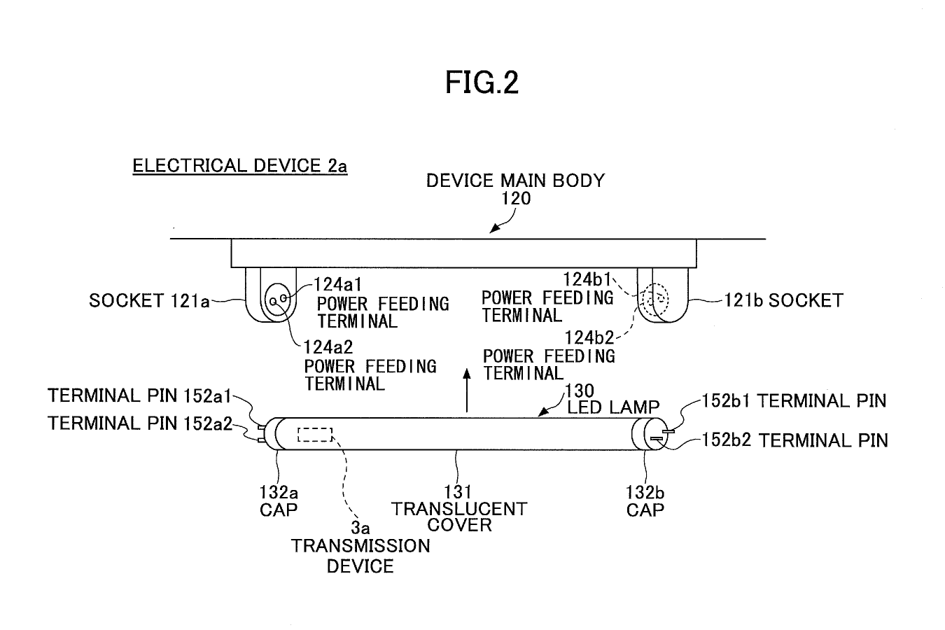

Next, with reference to FIG. 2, a description is given of the external view of the electrical device 2a which is a fluorescent light type LED light device as an example of the electrical device 2. Note that FIG. 2 is an external view of the electrical device when the electrical device is a fluorescent light type LED light device.

As illustrated in FIG. 2, the electrical device 2a as a fluorescent light type LED light device is a straight tube lamp, which is constituted by a device main body 120 attached to the ceiling β of the indoor location α illustrated in FIG. 1, and a LED lamp 130 attached to the device main body 120.

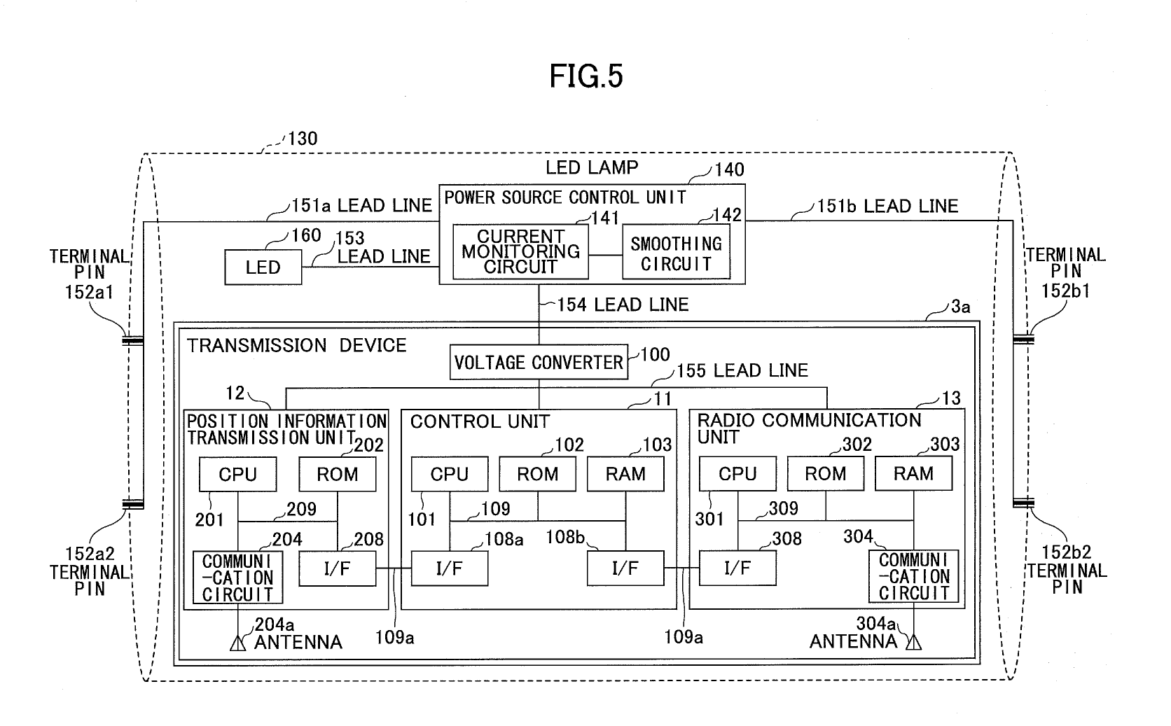

A socket 121a and a socket 121b are provided on respective ends of the device main body 120. Of these two sockets, the socket 121a includes power feeding terminals (124a1, 124a2) for feeding power to the LED lamp 130. Furthermore, the socket 121b also includes power feeding terminals (124b1, 124b2) for feeding power to the LED lamp 130. Accordingly, the device main body 120 can supply the power from a power source 1000 (see FIG. 4) described below to the LED lamp 130.

Meanwhile, the LED lamp 130 includes a translucent cover 131, caps (132a, 132b) provided on respective ends of the translucent cover 131, and the transmission device 3a provided inside the translucent cover 131. Among these, the translucent cover 131 is formed of a resin material such as acrylic resin, and is provided to cover the inside light source.

Furthermore, the cap 132a has terminal pins (152a1, 152a2) respectively connected to the power feeding terminals (124a1, 124a2) of the socket 121a. Furthermore, the cap 132b has terminal pins (152b1, 152b2) respectively connected to the power feeding terminals (124b1, 124b2) of the socket 121b. Furthermore, as the LED lamp 130 is mounted to the device main body 120, power can be supplied from the device main body 120 via the power feeding terminals (124a1, 124a2, 124b1, 124b2) through the terminal pins (152a1, 152a2, 152b1, 152b2). Accordingly, the LED lamp 130 radiates light outside via the translucent cover 131. Furthermore, the transmission device 3a operates by the power supplied from the device main body 120.

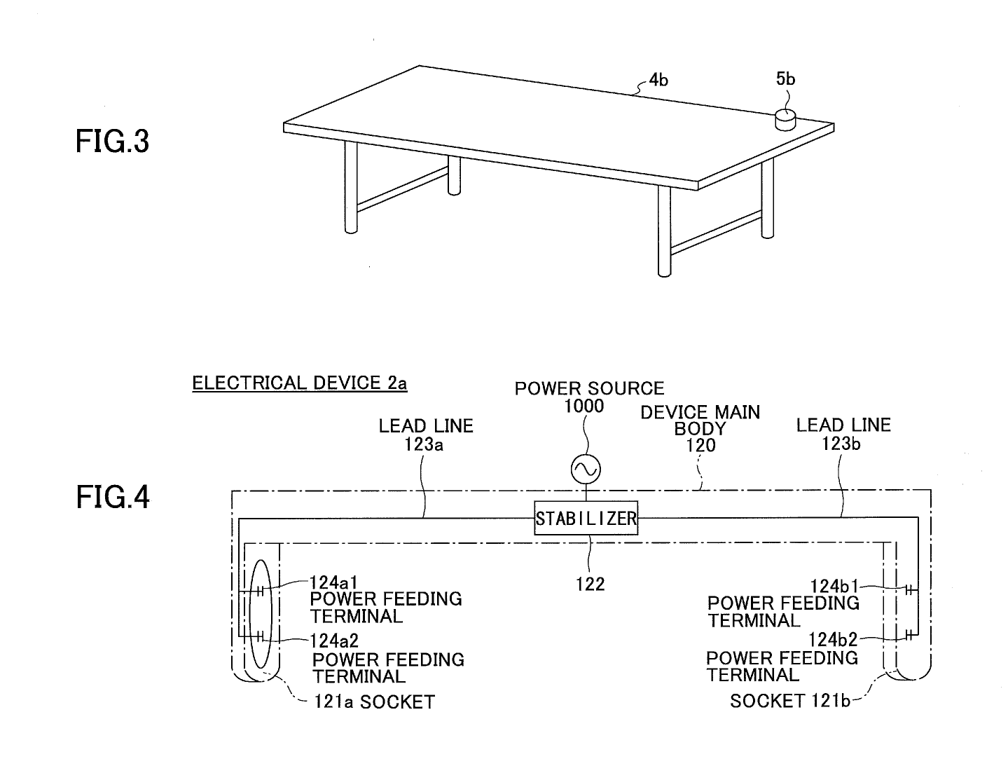

Next, with reference to FIG. 3, as an example of the management object 4, a description is given of a state where the communication terminal 5b is placed on the top surface of the management object 4b that is a table. Note that FIG. 3 is a pictorial diagram illustrating the state where the communication terminal 5b is provided on the management object 4b.

As illustrated in FIG. 3, on the top surface of the management object 4b, the communication terminal 5b is attached. For example, the communication terminal 5b may be attached by double-sided tape onto the management object 4b, or may be simply placed on the management object 4b.

Next, with reference to FIGS. 4 and 5, a description is given of a hardware configuration in a case where the electrical device is an LED light device. Note that FIG. 4 illustrates a hardware configuration of the device main body 120 when the electrical device is an LED light device. FIG. 5 illustrates a hardware configuration of a fluorescent light type LED lamp when the electrical device is an LED light device.

As illustrated in FIG. 4, the device main body 120 is mainly constituted by a stabilizer 122, lead lines (123a,123b), and power feeding terminals (124a1, 124a2, 124b1, 124b2).

Among these, the stabilizer 122 controls the current supplied from an external power source 1000. The stabilizer 122 and the power feeding terminals (124a1, 124a2, 124b1, 124b2) are electrically connected by the lead lines (123a,123b). Accordingly, power can be stably supplied from the stabilizer 122 via the lead lines (123a,123b) to the power feeding terminals (124a1, 124a2, 124b1, 124b2).

Furthermore, as illustrated in FIG. 5, the LED lamp 130 is mainly constituted by a power source control unit 140, lead lines (151a, 151b), terminal pins (152a1, 152a2, 152b1, 152b2), a lead line 153, a lead line 154, a lead line 155, and a transmission device 3a. Among these, the power source control unit 140 controls the current output from the power source 1000, and is mainly constituted by a current monitoring circuit 141 and a smoothing circuit 142. The current monitoring circuit 141 rectifies a current output from the power source 1000 and input to the current monitoring circuit 141. The smoothing circuit 142 smoothens the current rectified by the current monitoring circuit 141, and supplies power via the lead lines (151a, 151b) to the terminal pins (152a1, 152a2, 152b1, 152b2).

Furthermore, the power source control unit 140 and the terminal pins (152a1, 152a2, 152b1, 152b2) are electrically connected by the lead lines (151a, 151b). The power source control unit 140 and the transmission device 3a are electrically connected by the lead line 154. Note that only one LED 160 is illustrated in FIG. 5 due to the limited area in the page; however, actually a plurality of LEDs are attached. Furthermore, among the elements illustrated in FIG. 5, the elements other than the transmission device 3a are the same as those of a typical LED lamp.

Next, a description is given of the transmission device 3a. The transmission device 3a is constituted by a voltage converter 100, a lead line 155, a control unit 11, a position information transmission unit 12, and a radio communication unit 13. The voltage converter 100 is electrically connected to the control unit 11, the position information transmission unit 12, and the radio communication unit 13 via the lead line 155.

Among these, the voltage converter 100 is an electronic component that converts the voltage of the power supplied from the power source control unit 140 into the driving voltage of the transmission device 3a, and supplies the power to the control unit 11, the position information transmission unit 12, and the radio communication unit 13.

Furthermore, the control unit 11 includes a CPU (Central Processing Unit) 101 for controlling operations of the entire control unit 11, a ROM (Read-Only Memory) 102 storing a basic input output program, a RAM (Random Access Memory) 103 used as the work area of the CPU 101, I/F (108a, 108b) for sending and receiving signals to/from the position information transmission unit 12 and the radio communication unit 13, and a bus line 109 such as an address bus and a data bus for electrically connecting the above units.

Furthermore, the position information transmission unit 12 includes a CPU 201 for controlling operations of the entire position information transmission unit 12, a ROM 202 storing a basic input output program and position information Xa, a communication circuit 204 and an antenna 204a for transmitting the position information Xa, an I/F 208 for sending and receiving signals to and from the control unit 11, and a bus line 209 such as an address bus and a data bus for electrically connecting the above units.

Among these, the communication circuit 204 uses IMES, which is an indoor positioning technology referred to as indoor GPS, to transmit position information Xa by the antenna 204a. Note that in FIG. 1, the range where the position information X can reach (range where transmission is possible) is virtually expressed by dashed lines. In the IMES according to the present embodiment, the transmission output is set such the virtual circle, to which the position information X can reach, illustrated on the floor of the indoor location α, has a radius of approximately 5 m when the height of the ceiling of the indoor location α is approximately 3 m. However, by changing the setting of this transmission output, the radius can be made less than or greater than 5 m.

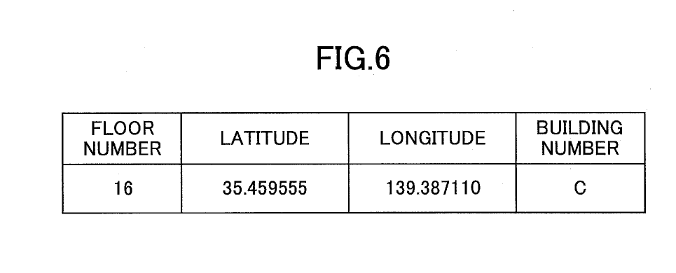

Furthermore, the position information Xa indicates the position where the electrical device 2a, which is a fluorescent light type LED light device, is installed. As illustrated in FIG. 6, the position information Xa includes the items of the floor number, the latitude, the longitude, and the building number. Note that FIG. 6 is a conceptual diagram of the position information that is transmitted by the transmission device.

Among these items, the floor number expresses the floor number of the building in which the electrical device 2a is installed. The latitude and the longitude express the latitude and the longitude of the position where the electrical device 2a is installed. The building number expresses the building number of the building in which the electrical device 2a is installed. In the example illustrated in FIG. 6, it is indicated that the electrical device 2a is installed on the sixteenth floor of the C building, at a spot at latitude 35.459555 degrees north and longitude 139.387110 degrees east. Note that the latitude may be expressed by the south latitude and the longitude may be expressed by the west longitude.

Furthermore, referring back to FIG. 5, the radio communication unit 13 includes a CPU 301 for controlling the operations of the entire radio communication unit 13, a ROM 302 storing a basic input output program and device identification information Ba, a RAM 303 used as the work area of the CPU 301, a communication circuit 304 and an antenna 304a for receiving position information Xa and terminal identification information Aa and sending this information to the gateway 7, an I/F 308 for sending/receiving signals with the control unit 11, and a bus line 309 such as an address bus and a data bus for electrically connecting the above units.

Furthermore, the radio communication unit 13 sends/receives data by using the 920 MHz band. The 920 MHz band has high radio wave reachability, and therefore even when there are columns and walls of the building between the transmission device 3a and the gateway 7, data can be sent from the transmission device 3a to the gateway 7.

Furthermore, the communication circuit 304 uses the specification of at least the physical layer of the architecture model of the IEEE802.15.4 specification, to send/receive data by the antenna 304a. Furthermore, in this case, a MAC address may be used as the device identification information B for identifying the transmission device 3 (radio communication unit 13).

Note that it is possible to use ZigBee (registered trademark) using the physical layer and the MAC layer in the architecture model of the IEEE802.15.4 specification. In this case, according to the usage area in Japan, the US, Europe, etc., the transmission device 3 uses the 800 MHz band, the 900 MHz band, or the 2.4 GHz band, to send data to the gateway 7 via another adjacent transmission device 3. By using such multi-hop communication of sending data via another transmission device 3, power can be saved when driving the radio communication unit 13 of each transmission device 3. This is possible because the radio communication unit 13 only needs to communicate the data with power required for reaching the closest transmission device 3, even though it takes time for performing the routing process.

Furthermore, the position information Xa may be stored in a storage unit 29 by the manufacturer before the transmission device 3a is shipped from the factory, or may be stored by the installer when the electrical device 2a is installed on the ceiling β after the transmission device 3a is shipped from the factory. Furthermore, the position information Xa may be received by the communication circuit 304 of the radio communication unit 13 by radio communication via the gateway 7, from a device outside the position information management system 9, and may be stored in the ROM 202 of the position information transmission unit 12 via the control unit 11.

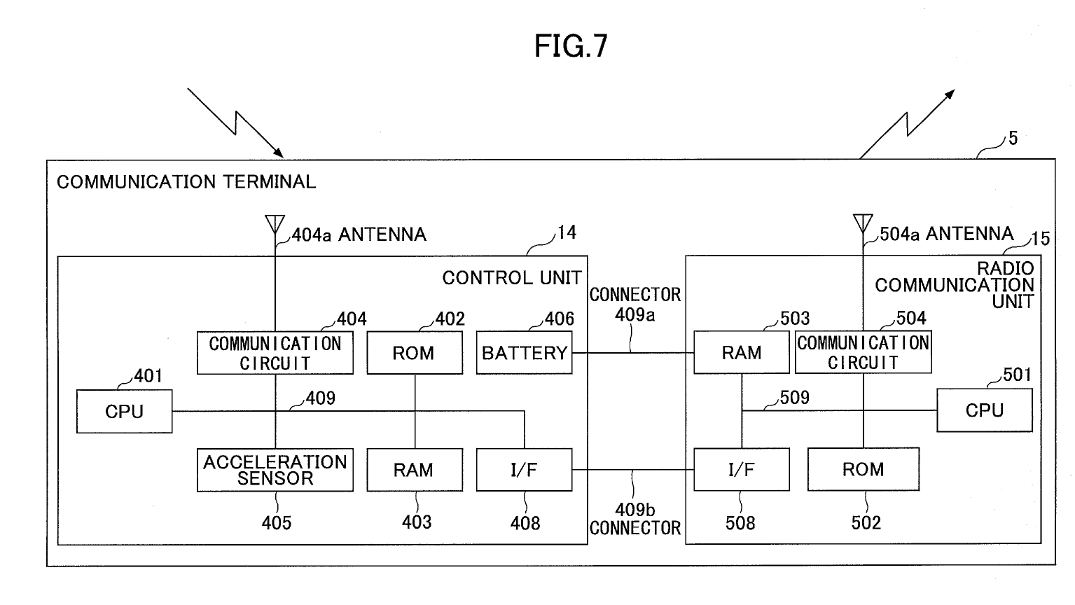

Next, with reference to FIG. 7, a description is given of the hardware configuration of the communication terminal 5. Note that FIG. 7 is a hardware configuration diagram of the communication terminal 5.

As illustrated in FIG. 7, the communication terminal 5 is constituted by a control unit 14 and a radio communication unit 15.

The control unit 14 includes a CPU 401 for controlling the operations of the entire control unit 14, a ROM 402 storing a basic input output program, a RAM 403 used as the work area of the CPU 401, a communication circuit 404 and an antenna 404a for receiving the position information X, an acceleration sensor 405 for detecting the acceleration, an I/F 408 for sending and receiving signals with the radio communication unit 15, and a bus line 409 such as an address bus and a data bus for electrically connecting the above units. Furthermore, the control unit 14 is also provided with a button battery 406, and is driven by this button battery 406. Note that the present embodiment is described as using the button battery 406; however, the battery is not limited to a button type. A dry-cell battery such as an AA battery or an AAA battery, or a battery exclusively used by the communication terminal 5 may be used.

The communication circuit 404 receives, with the antenna 404a, the position information X transmitted with the use of IMES. Furthermore, the control unit 14 supplies power of the button battery 406 to the radio communication unit 15 via a connector 409a. Furthermore, the control unit 14 sends and receives data (signals) with the radio communication unit 15 from the I/F 408 via a connector 409b.

Furthermore, the acceleration sensor 405 detects the change in the acceleration of the communication terminal 5. For example, the change in the acceleration is detected when the communication terminal 5 starts moving, when the communication terminal 5 stops moving, or when the communication terminal 5 is tilted. When processing by the CPU 401 is stopped, and the acceleration sensor 405 detects a change in the acceleration, the acceleration sensor 405 sends signals to the CPU 401 to cause the CPU 401 to start processing. Accordingly, the CPU 401 starts its own processing, and also sends signals to the communication circuit 404 to cause the communication circuit 404 to start processing. Thus, while the position information X is being transmitted from the transmission device 3, the communication circuit 404 of the communication terminal 5 can start receiving the position information X via the antenna 404a.

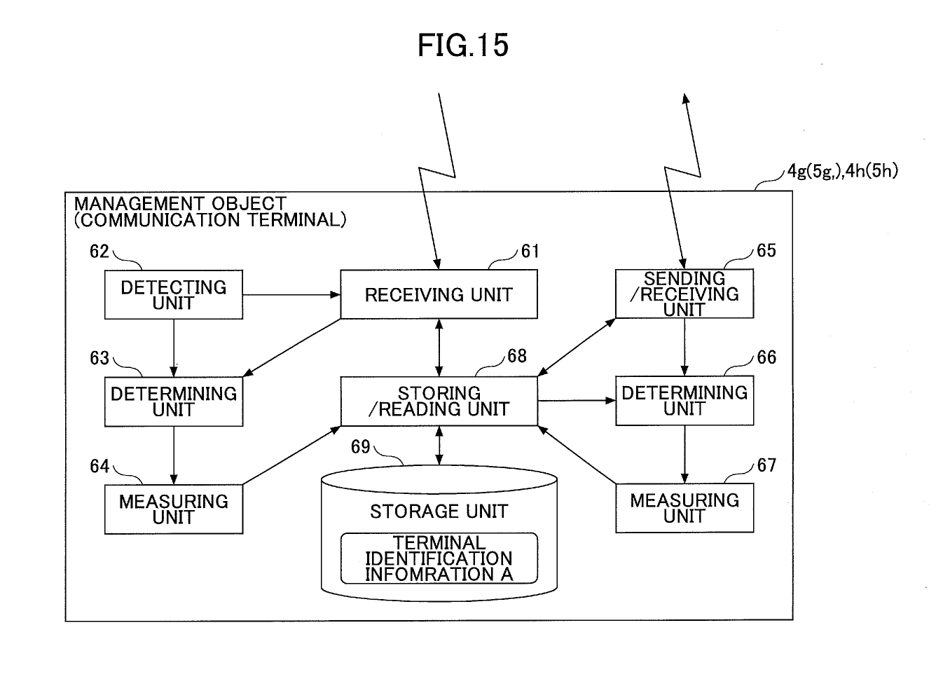

Meanwhile, the radio communication unit 15 basically has the same configuration as the radio communication unit 13, and sends and receives data with the radio communication unit 13 of the transmission device 3, by using the same bandwidth as the radio communication unit 13. Furthermore, as illustrated in FIG. 15, the radio communication unit 15 includes a CPU 501 for controlling the operations of the entire radio communication unit 15, a ROM 502 storing a basic input output program and terminal identification A, a RAM 503 used as the work area of the CPU 501, a communication circuit 504 and an antenna 504a for sending position information X and terminal identification information A, an I/F 508 for sending and receiving signals with the control unit 14, and a bus line 509 such as an address bus and a data bus for electrically connecting the above units. Note that also in the radio communication unit 15, ZigBee may be used.

Furthermore, the communication circuit 504 acquires position information X stored in the RAM 403 of the control unit 14 via the connector 409b, according to an instruction from the CPU 501. Furthermore, the communication circuit 504 reads the terminal identification information A stored in the ROM 502, and sends the terminal identification information A together with the position information X acquired as described above, to the transmission device 3 via the antenna 504a.

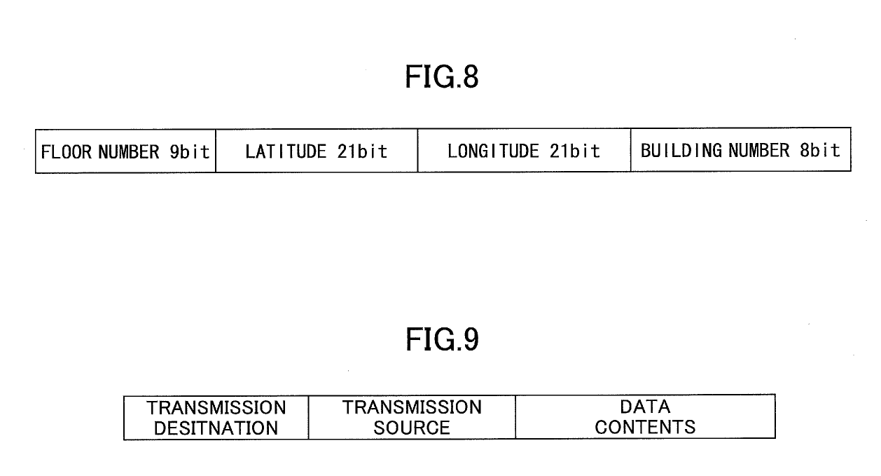

Furthermore, the data of the position information X sent by the communication circuit 504 is constituted by the format as illustrated in FIG. 8. Note that FIG. 8 is a conceptual diagram of the format of the data of the position information. In the example of FIG. 8, the fields of the floor number, the latitude, the longitude, and the building number are expressed by 9 bits, 21 bits, 21 bits, and 8 bits, respectively, and the expression format of the fields is based on the IMES specification. Actually, in addition to this format, a header and check-sum information defined by a communication method are added, and as illustrated in FIG. 9, the transmission destination, the transmission source, and data contents (position information X, etc.) are included. Note that FIG. 9 is a conceptual diagram illustrating the data structure of data including the position information.

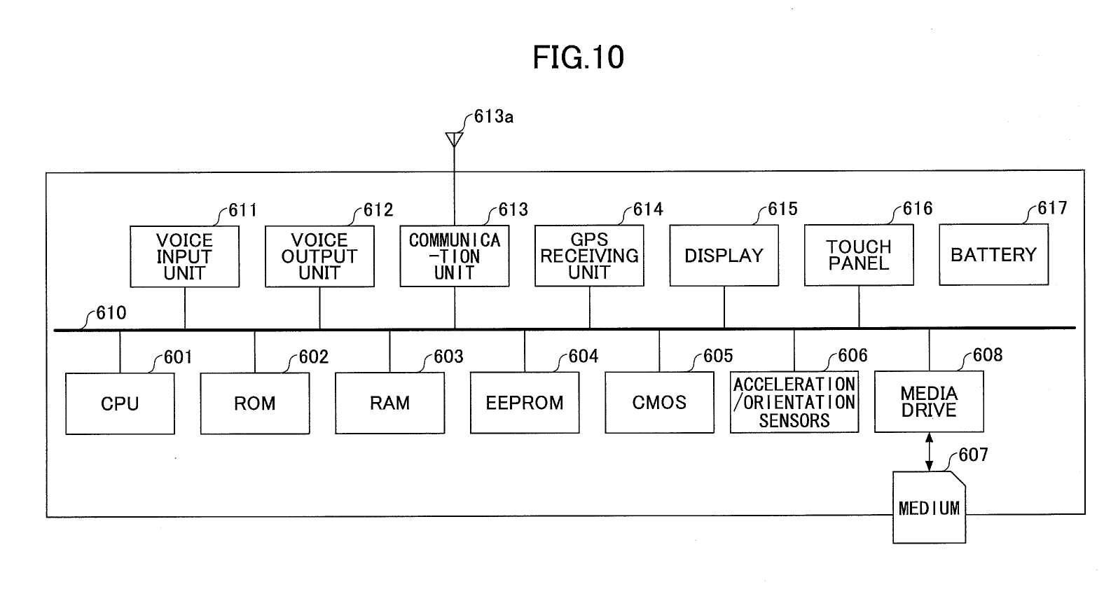

Next, with reference to FIG. 10, a description is given of a hardware configuration of a mobile phone, which is the management object 4h (communication terminal 5h). Note that FIG. 10 is a hardware configuration diagram in a case where the management object is a mobile phone.

As illustrated in FIG. 10, the management object 4h (communication terminal 5h) includes a CPU 601 for controlling the operations of the entire communication terminal 5h, a ROM (Read Only Memory) 602 storing a basic input output program, a RAM 603 used as the work area of the CPU 601, an EEPROM (Electrically Erasable and Programmable ROM) 604 that reads or writes data according to control by the CPU 601, a CMOS (Complementary Metal Oxide Semiconductor) sensor 605 that obtains image data by imaging a subject according to control by the CPU 601, various acceleration/orientation sensors 606 such as an electromagnetic compass for detecting the geomagnetism, a gyrocompass, and an acceleration sensor, and a media drive 608 for controlling the reading or writing (storing) of data with respect to a recording medium 607 such as a flash memory. The recording medium 607 is removable, and according to control by the media drive 608, data that has already been recorded is read from the recording medium 607 or new data is written in and stored in the recording medium 607.

Note that the EEPROM 604 stores an operating system (OS) executed by the CPU 601, other programs and various data. Furthermore, the CMOS sensor 605 is a charge-coupled device for digitizing an image of a subject by converting light into electric charges. As long as the CMOS sensor 605 can image a subject, the sensor is not limited to a COMS sensor; the sensor may be a charge-coupled device (CCD) sensor.

Furthermore, the management object 4h (communication terminal 5h) includes a voice input unit 611 for converting a voice into voice signals, a voice output unit 612 for converting the voice signals into a voice, an antenna 613a, a communication unit 613 for communicating with the closest base station 8a by radio communication signals using this antenna 613a, a GPS receiving unit 614 for receiving GPS signals from the GPS satellite 999, a display 615 such as a liquid crystal display or an organic EL display for displaying images of subjects and various icons, a touch panel 616 constituted by a pressure-sensitive panel or an electrostatic panel which is placed on the display 615 and which is used for detecting the touch position on the display 615 when touched by a finger or a touch pen, and a bus line 610 such as an address bus and a data bus for electrically connecting the above units. Furthermore, the management object 4h (communication terminal 5h) includes an exclusively used battery 617, and is driven by this battery 617. Note that this voice input unit 611 includes a microphone for inputting voices, and the voice output unit 612 includes a speaker for outputting voices.

Furthermore, the GPS receiving unit 614 of the management object 4h (communication terminal 5h) is the same as a GPS receiving unit included in a typical mobile phone. However, the firmware in the program stored in the ROM 602 is fine-adjusted, so that data can be received in a seamless manner from the transmission device 3 in the indoor location α and a GPS satellite in the outdoor location γ. Note that the acceleration/orientation sensors 606 performs operations including the process of the CMOS sensor 605 in FIG. 7.

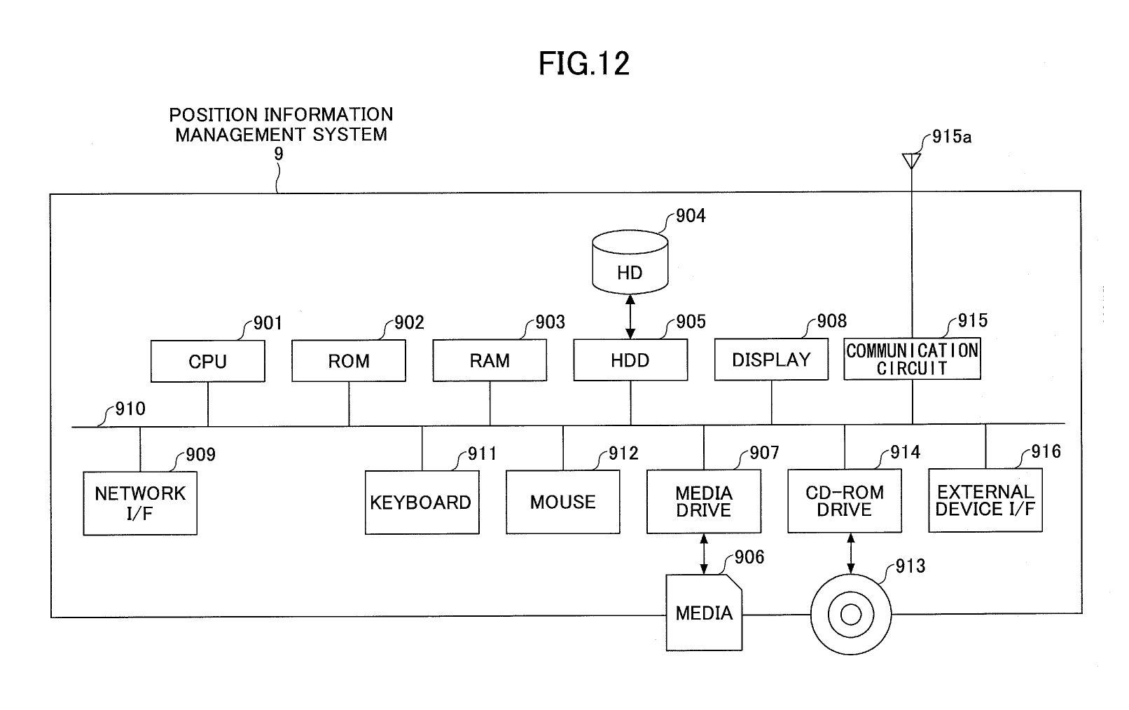

Note that the hardware configuration of a personal computer that is the management object 4g (communication terminal 5g) is the same as that of the position information management system 9 illustrated in FIG. 12 described below, and descriptions thereof are thus omitted. However, in the case where a personal computer is the management object 4g (communication terminal 5g), a GPS antenna is connected to an external device I/F 916 such as a USB (Universal Serial Bus) connecter illustrated in FIG. 12. Depending on the personal computer, a GPS antenna may already be installed, in which case there is no need to connect a GPS antenna to the external device I/F 916.

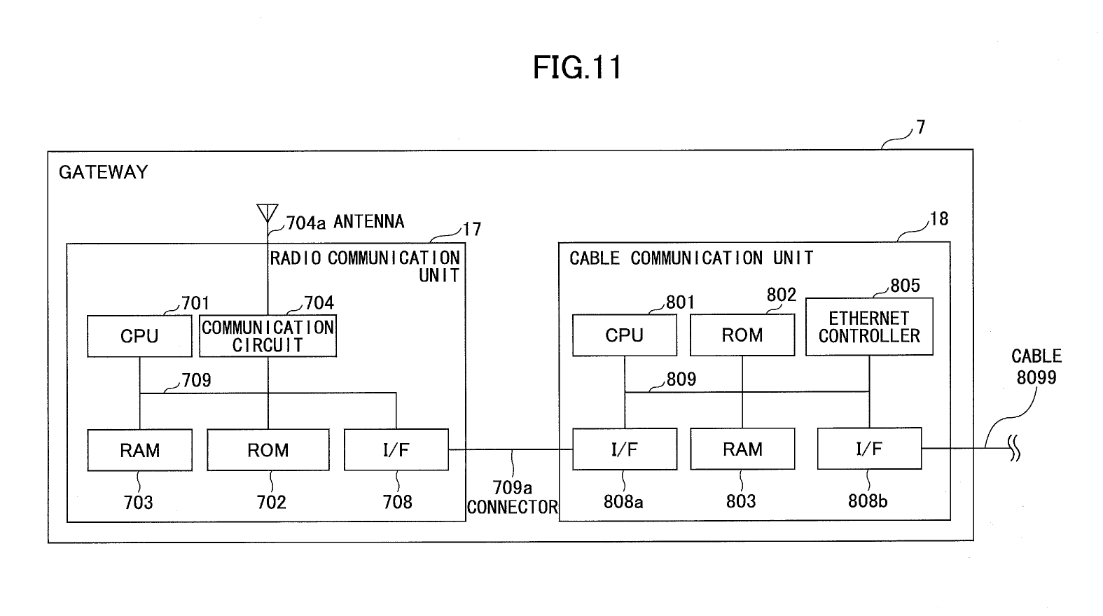

Next, with reference to FIG. 11, a description is given of a hardware configuration of the gateway 7. Note that FIG. 11 illustrates a hardware configuration of the gateway 7.

As illustrated in FIG. 11, the gateway 7 includes a radio communication unit 17 and a cable communication unit 18.

The radio communication unit 17 basically has the same configuration as that of the radio communication unit 13 described above, and uses the same bandwidth as that of the radio communication unit 13, to send and receive data with the radio communication unit 13 of the transmission device 3. As illustrated in FIG. 11, the radio communication unit 17 includes a CPU 701 for controlling the operations of the entire radio communication unit 17, a ROM 702 storing a basic input output program and device identification information C, a RAM 703 used as the work area of the CPU 701, a communication circuit 704 and an antenna 704a for sending position information X, an I/F 708 for sending and receiving signals with the cable communication unit 18, and a bus line 709 such as an address bus and a data bus for electrically connecting the above units. Furthermore, the radio communication unit 17 sends and receives signals with the cable communication unit 18 via a connector 709a from the I/F 708.

Note that also in the radio communication unit 17, ZigBee may be used. Furthermore, the device identification information C is unique information for identifying the gateway 7 (radio communication unit 17). For example, as the device identification information C, a MAC address may be used.

Meanwhile, as illustrated in FIG. 11, the cable communication unit 18 includes a CPU 801 for controlling the operations of the entire cable communication unit 18, a ROM 802 storing a basic input output program and device identification information D, a RAM 803 used as the work area of the CPU 801, an Ethernet controller 805, an I/F 808a for sending and receiving signals with the radio communication unit 17, an I/F 808b for sending and receiving data (signals) with the LAN 8e via a cable 8099, and a bus line 809 such as an address bus and a data bus for electrically connecting the above units.

The CPU 801 and the Ethernet controller 805 implement control so that various data (information) sent from the transmission device 3 can be used for packet communication of Ethernet (registered trademark), by converting the communication method (communication protocol) complying with IEEE802.15.4, into a communication method (communication protocol) complying with IEEE802.3.

Furthermore, the device identification information D is unique information for identifying the gateway 7 (cable communication unit 18). For example, as the device identification information D, an IP′ (Internet Protocol) address may be used. Note that the ROM 802 stores a MAC address; however, as a matter of simplifying the description of communications with the position information management system 9, descriptions of the MAC address are omitted.

Next, with reference to FIG. 12, a description is given of a hardware configuration of the position information management system 9. Note that FIG. 12 illustrates a hardware configuration of the position information management system 9.

The position information management system 9 is constituted by a computer. The position information management system 9 includes a CPU 901 for controlling the operations of the entire position information management system 9, a ROM 902 for storing programs used for driving the CPU 901 such as IPL (Initial Program Loader), a RAM 903 used as the work area of the CPU 901, a HD 904 for storing various data of programs of the position information management system 9 and system identification information E, a HDD (Hard Disk Drive) 905 for controlling the reading or writing of various data with respect to the HD 904 according to control implemented by the CPU 901, a media drive 907 for controlling the reading or writing (storing) of data with respect to a recording media 906 such as a flash memory, a display 908 for displaying various information such as a cursor, a menu, windows, characters, or images, a network I/F 909 for performing data communications by using the communication network 8, a keyboard 911 including a plurality of keys for inputting characters, numbers and various instructions, a mouse 912 for selecting and executing various instructions, selecting a process object, and moving the cursor, a CD-ROM drive 914 for implementing control to read or write various data with respect to a CD-ROM (Compact Disc Read Only Memory) 913 which is an example of a removable recording medium, a communication circuit 915 and an antenna 915a for performing radio communication, an external device I/F 916 for connecting an external device, and a bus line 910 such as an address bus and a data bus for electrically connecting the above elements.

Furthermore, the system identification information E is unique information for identifying the position information management system 9. As an example of the system identification information E, an IP address may be used. Note that the ROM 902 stores a MAC address; however, as a matter of simplifying the description of communications with the gateway 7, descriptions of the MAC address are omitted.

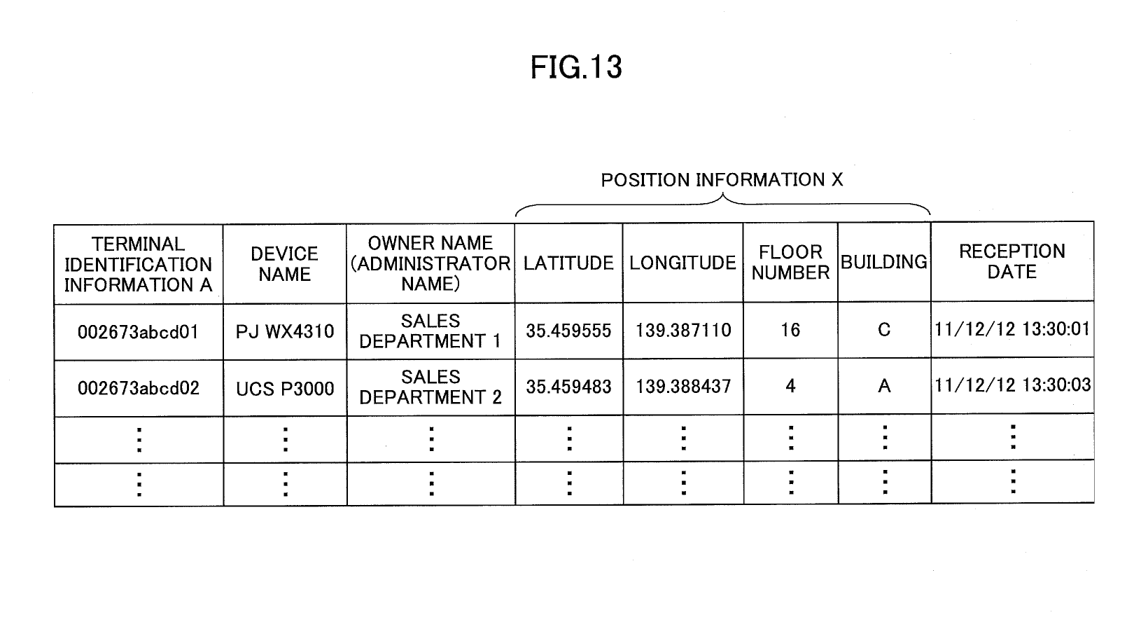

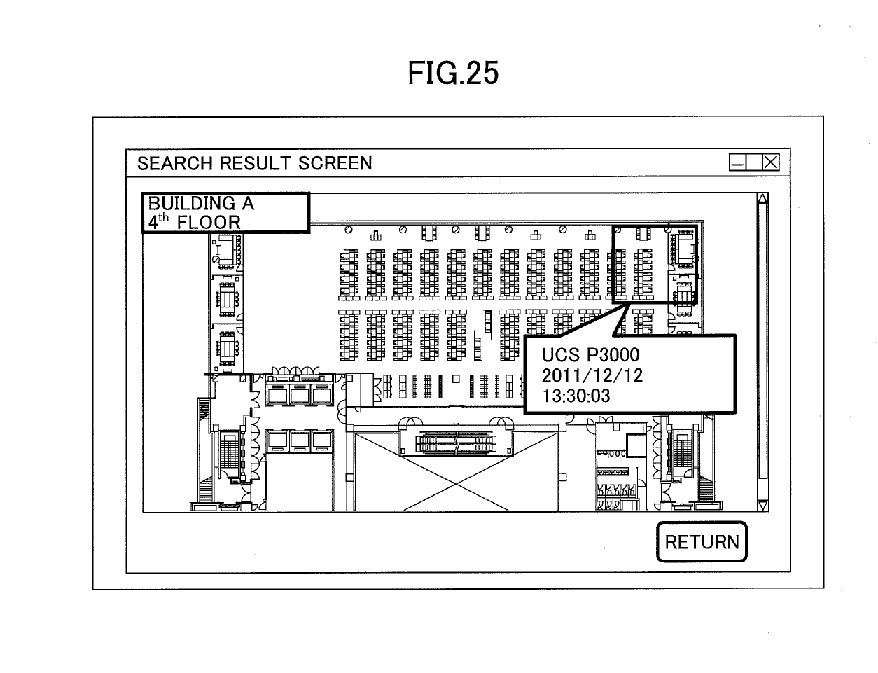

Furthermore, in the HD 904, management information F as illustrated in FIG. 13, and layout information G of a particular floor as illustrated in FIG. 25, are managed. Note that FIG. 13 is a conceptual diagram of management information managed by the position information management system 9.

As illustrated in FIG. 13, in the management information F, various information such as terminal identification information A, a device name, an owner name (administrator name), position information X, and the reception date, are associated with each other.

Among these information items, the terminal identification information A is information for identifying the communication terminal 5 as described above. The device name is the name of the management object 4 or the name of the communication terminal 5. The owner name (administrator name) is the name of the owner or the administrator of the communication terminal 5. The position information X is the information illustrated in FIG. 6. The reception date is the date when the position information management system 9 has received the position information X from the gateway 7.

Furthermore, the terminal identification information A, the device name, and the owner name (administrator name) are managed in association with each other in the position information management system 9 in advance. The position information management system 9 receives the position information X and the terminal identification information A from the gateway 7, and adds the position information X and the reception date to the record including the same terminal identification information A in the management information F.

Furthermore, when the position information management system 9 newly receives position information X and terminal identification information A from the gateway 7 in a state where the position information X and a reception date are already managed, the position information X and the reception date that are already managed are overwritten by the newly received information.

Note that the position information management system 9 may additionally write in information by creating a new record, without overwriting the position information X and the reception date.

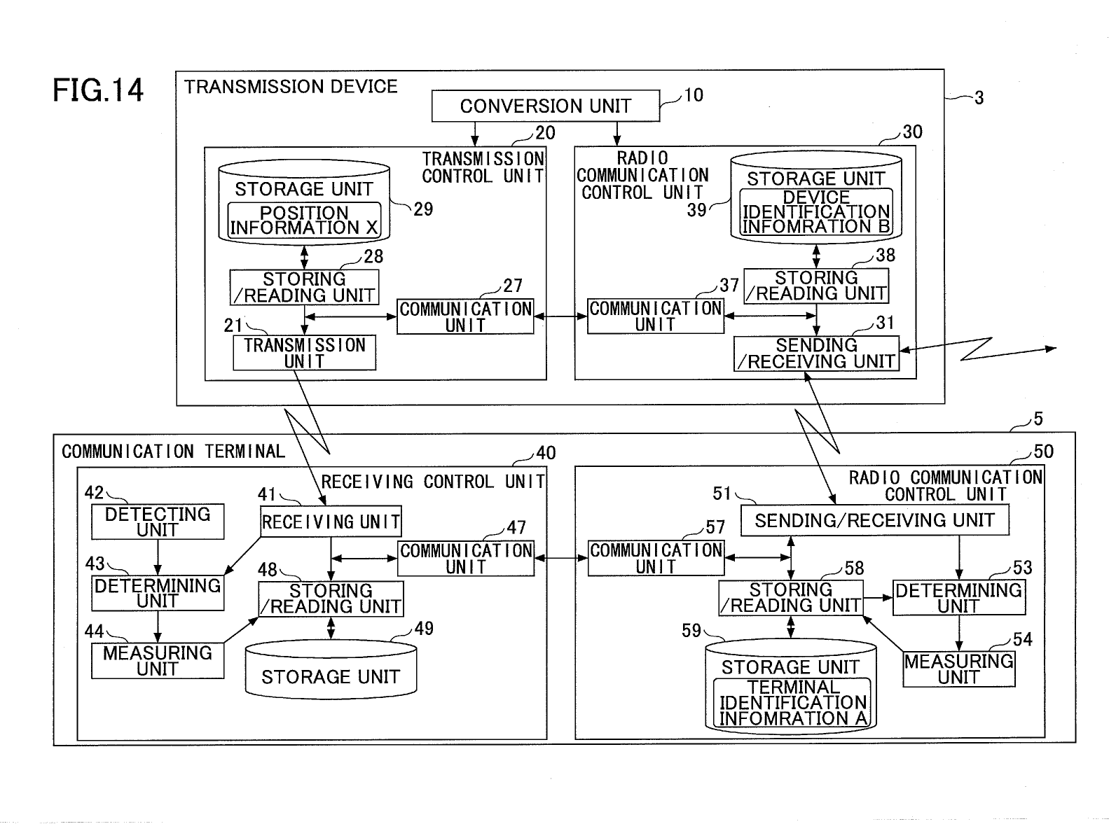

Next, with reference to FIGS. 14 through 16, a description is given of the functional configuration of the position management system 1. When describing the functional configuration with reference to FIGS. 14 through 16, the relationship with the hardware configurations illustrated in FIGS. 5, 7, 10, 11, and 12 are also briefly explained.

FIG. 14 is a functional block diagram of the transmission device 3 and the communication terminal 5. As illustrated in FIG. 14, the transmission device 3 includes, as a function or a unit, a conversion unit 10, a transmission control unit 20, and a radio communication control unit 30. Among these, the conversion unit 10 is a function or a unit realized by operations of the voltage converter 100 illustrated in FIG. 5.

Furthermore, the transmission control unit 20 is a function or a unit realized by operations of the control unit 11 and the position information transmission unit 12 illustrated in FIG. 5. Furthermore, the radio communication control unit 30 is a function or a unit realized by operations of the control unit 11 and the radio communication unit 13 illustrated in FIG. 5.

The transmission control unit 20 includes a storage unit 29 constructed by the ROM 202 illustrated in FIG. 5. The storage unit 29 stores the above position information X. Furthermore, the transmission control unit 20 includes a transmission unit 21, a communication unit 27, and a storing/reading unit 28.

Among these, the transmission unit 21 is mainly realized by processes by the CPU 201 and the communication circuit 204 illustrated in FIG. 5, and transmits the position information X to a range where transmission is possible.

The communication unit 27 is mainly realized by processes by the CPU (101, 201), and the I/F (108a, 208) and the bus (109, 209) illustrated in FIG. 5, and communicates data (signals) with the radio communication control unit 30.

The storing/reading unit 28 is realized by processes by the CPU (101, 201), and stores various data in the storage unit 29 and reads various data from the storage unit 29. For example, the storing/reading unit 28 stores and reads the data of the position information X.

Furthermore, the radio communication control unit 30 includes a storage unit 39 constructed by the RAM 303 illustrated in FIG. 5. The storage unit 39 stores the device identification information B described above.

A sending/receiving unit 31 is mainly realized by processes by the CPU 301 and the communication circuit 304 illustrated in FIG. 5, and sends and receives various data with the communication terminal 5 or the gateway 7 by radio communication.

A communication unit 37 is mainly realized by processes by the CPU (101, 301), the I/F (108B, 308), and the bus (109, 309), and communicates data (signals) with the transmission control unit 20.

A storing/reading unit 38 stores various data in the storage unit 39, and reads various data from the storage unit 39.

Next, a description is given of the functional configuration of the communication terminal 5.

The communication terminal 5 includes, as a function or a unit, a receiving control unit 40 and a radio communication control unit 50.

The receiving control unit 40 includes a storage unit 49 constructed by the RAM 403 illustrated in FIG. 7. The storage unit 49 may store the position information X transmitted from the transmission device 3. Furthermore, the receiving control unit 40 includes a receiving unit 41, a detecting unit 42, a determining unit 43, a measuring unit 44, a communication unit 47, and a storing/reading unit 48.

Among these, the receiving unit 41 is mainly realized by processes by the CPU 401 and the communication circuit 404 illustrated in FIG. 7, and receives position information X transmitted from the transmission device 3. Furthermore, the receiving unit 41 switches between a state where the position information X can be received and a state where the position information X cannot be received.

The detecting unit 42 is mainly realized by processes by the CPU 401 and the acceleration sensor 405 illustrated in FIG. 7, and detects the movement of the communication terminal 5 (including tilt), and causes the receiving unit 41 to start processing. Note that the detecting unit 42 may be realized by a motion sensor using inertia force and magnetism, instead of the acceleration sensor 405.

The determining unit 43 is mainly realized by processes by the CPU 401 illustrated in FIG. 7, and determines whether the receiving unit 41 has received at least one piece of position information X. Furthermore, the determining unit 43 determines whether the receiving unit 41 has received the respective position information X from the plurality of transmission devices 3. Note that in this case, the position information X transmitted from the same transmission device 3 is handled as one piece of position information X, even if the same information is repeatedly received within a predetermined time.

The measuring unit 44 is mainly realized by processes by the CPU 401 illustrated in FIG. 7, and when the determining unit 43 determines that the respective position information X is received from a plurality of transmission devices 3, the measuring unit 44 measures the signal intensity relevant to the respective position information X.

The communication unit 47 is mainly realized by processes by the CPU 401, and the I/F 408 and the bus line 409 illustrated in FIG. 7, and communicates data (signals) with the radio communication control unit 50.

The storing/reading unit 48 is realized by processes by the CPU 401, and stores various data in the storage unit 49 and reads various data from the storage unit 49. For example, the storing/reading unit 48 stores and reads data of the position information X.

Furthermore, the radio communication control unit 50 includes a storage unit 59 constructed by the RAM 503 illustrated in FIG. 5. The storage unit 59 stores the terminal identification information A described above. Furthermore, the radio communication control unit 50 includes a sending/receiving unit 51, a determining unit 53, a measuring unit 54, a communication unit 57, and a storing/reading unit 58.

The sending/receiving unit 51 is mainly realized by processes by the CPU 501 and the communication circuit 504 illustrated in FIG. 7, and sends and receives various data with the transmission device 3 by radio communication.

The determining unit 53 is mainly realized by processes by the CPU 501 illustrated in FIG. 7, and determines whether the sending/receiving unit 51 has received at least one piece of device identification information B. Furthermore, the determining unit 53 determines whether the sending/receiving unit 51 has received the respective device identification information B from a plurality of transmission devices 3. Note that in this case, the device identification information B that has been sent from the same transmission device 3 is handled as one piece of device identification information B, even if the same information is repeatedly received within a predetermined time.

The measuring unit 54 is mainly realized by processes by the CPU illustrated in FIG. 7, and when the determining unit 53 determines that the respective device identification information B is received from a plurality of transmission devices 3, the measuring unit 54 measures the signal intensity of the respective device identification information B.

The communication unit 57 is mainly realized by processes by the CPU 501 and the I/F 508 and the bus line 509 illustrated in FIG. 7, and communicates data (signals) with the receiving control unit 40.

The storing/reading unit 58 is mainly realized by processes by the CPU 501 illustrated in FIG. 7, and stores various data in the storage unit 59 and reads various data from the storage unit 59. For example, the storing/reading unit 58 stores and reads data of the device identification information (A, B).

Next, with reference to FIG. 15, a description is given of the functional configuration of the management object (4g, 4h). Note that FIG. 15 is a functional block diagram in a case where the management object is a mobile phone or a personal computer.

As illustrated in FIG. 15, the management object (4g, 4h) includes a storage unit 69, which is constructed by the EEPROM 604 illustrated in FIG. 10, or the RAM 903 and the HD (Hard Disk) 904 illustrated in FIG. 12. Furthermore, the management object (4g, 4h) includes a receiving unit 61, a detecting unit 62, a determining unit 63, a measuring unit 64, a sending/receiving unit 65, a determining unit 66, a measuring unit 67, and a storing/reading unit 68.

Among these, the receiving unit 61 is mainly realized by processes by the CPU 601 and the GPS receiving unit 614 illustrated in FIG. 10, or processes by the CPU 901 and the GPS antenna connected to the external device I/F 916 illustrated in FIG. 12, and has the same function as that of the receiving unit 41.

The detecting unit 62 is mainly realized by processes by the CPU 601 and the acceleration/orientation sensors 606 illustrated in FIG. 10, or processes by the CPU 901 and the acceleration sensor connected to the external device I/F 916 illustrated in FIG. 12, and has the same function as that of the detecting unit 42.

The determining unit 63 is mainly realized by processes by the CPU 601 illustrated in FIG. 10, or by processes by the CPU 901 illustrated in FIG. 12, and has the same function as that of the determining unit 43.

The measuring unit 64 is mainly realized by processes by the CPU 601 illustrated in FIG. 10, or by processes by the CPU 901 illustrated in FIG. 12, and has the same function as that of the measuring unit 44.

The sending/receiving unit 65 is mainly realized by processes by the CPU 601 and the communication unit 613 illustrated in FIG. 10, or by processes by the CPU 901 and the communication circuit 915 illustrated in FIG. 12, and has the same function as that of the sending/receiving unit 51.

The determining unit 66 is mainly realized by processes by the CPU 601 illustrated in FIG. 10, or by processes by the CPU 901 illustrated in FIG. 12, and has the same function as that of the determining unit 53.

The measuring unit 67 is mainly realized by processes by the CPU 601 illustrated in FIG. 10, or by processes by the CPU 901 illustrated in FIG. 12, and has the same function as that of the measuring unit 54.

The storing/reading unit 68 is mainly realized by processes by the CPU 601 illustrated in FIG. 10, or by processes by the CPU 901 illustrated in FIG. 12, and has the same function as that of the storing/reading unit 48 or the storing/reading unit 58.

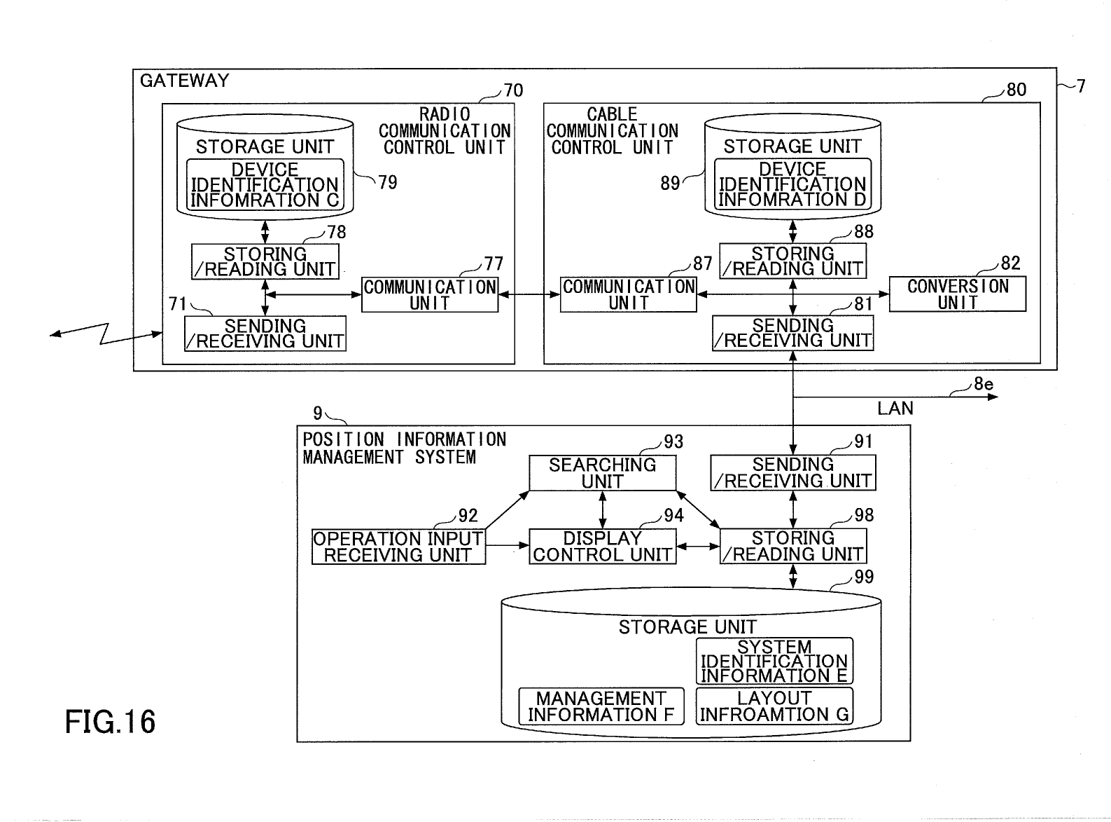

Next, with reference to FIG. 16, the function configuration of the gateway 7 is described. Note that the FIG. 16 is a functional block diagram of the gateway 7 and the position information management system 9.

The gateway 7 includes, as a function or a unit, a radio communication control unit 70 and a cable communication control unit 80.

The radio communication control unit 70 is realized by processes by the radio communication unit 17 illustrated in FIG. 11, and basically has the same function as that of the radio communication control unit 30 of the transmission device 3.

Specifically, the radio communication control unit 70 includes a storage unit 79, which is constructed by the RAM 703 illustrated in FIG. 11. This storage unit 79 stores the device identification information C described above. Furthermore, the radio communication control unit 70 includes a sending/receiving unit 71, a communication unit 77, and a storing/reading unit 78.

Among these, the sending/receiving unit 71 is mainly realized by processes by the CPU 701 and the communication circuit 704 illustrated in FIG. 11, and sends and receives various data with the transmission device 3 by radio communication.

The communication unit 77 is mainly realized by processes by the CPU 701, and the I/F 708 and the bus line 709, and communicates data (signals) with the cable communication control unit 80.

The storing/reading unit 78 is mainly realized by processes by the CPU 801, and stores various data in the storage unit 79 and reads various data from the storage unit 79.

Furthermore, the cable communication control unit 80 is realized by processes by the cable communication unit 18 illustrated in FIG. 11. The cable communication control unit 80 includes a storage unit 89 constructed by the RAM 803 illustrated in FIG. 11. The storage unit 89 includes the device identification information D described above. Furthermore, the cable communication control unit 80 includes a sending/receiving unit 81, a conversion unit 82, a communication unit 87, and a storing/reading unit 88.

Among these, the sending/receiving unit 81 is mainly realized by processes by the CPU 801 and the I/F 808b illustrated in FIG. 11, and sends and receives various data with the position information management system 9 by cable communication.

The conversion unit 82 is mainly realized by processes by the CPU 801 and the Ethernet controller 805 illustrated in FIG. 11, and by converting the communication method as described above, the conversion unit 82 implements control so that various data (information) sent from the transmission device 3 can be used for packet communication of Ethernet (registered trademark).

The communication unit 87 is mainly realized by processes by the CPU 801, and the I/F 808a and the bus line 809, and communicates data (signals) with the radio communication control unit 70.

The storing/reading unit 98 is mainly realized by processes by the CPU 801, and stores various data in the storage unit 89 and reads various data from the storage unit 89.

Next, with reference to FIG. 16, a description is given of a functional configuration of the position information management system 9.

The position information management system 9 includes a storage unit 99 constructed by the RAM 903 and the HD 904 illustrated in FIG. 12. The storage unit 99 stores the system identification information E, the management information F, and the layout information G described above. Furthermore, the position information management system 9 includes a sending/receiving unit 91, an operation input receiving unit 92, a searching unit 93, a display control unit 94, and a storing/reading unit 98.

Among these, the sending/receiving unit 91 is mainly realized by processes by the CPU 901, and the network I/F 909 and the communication circuit 915 illustrated in FIG. 12, and sends and receives various data with the gateway 7 by cable communication or radio communication. Furthermore, the sending/receiving unit 91 sends and receives various data with the communication terminal 5h at the outdoor location γ, via the communication network 8.

The operation input receiving unit 92 is mainly realized by processes by the CPU 901, and the keyboard 911 and the mouse 912, and receives various selections or inputs from the administrator.

The searching unit 93 is mainly realized by processes by the CPU 901, and searches the management information F in the storage unit 99 via the storing/reading unit 98 based on search conditions received by the operation input receiving unit 92, and outputs the search results.

The display control unit 94 is mainly realized by processes by the CPU 901, and implements control for displaying various images and characters on the display 908.

The storing/reading unit 98 is mainly realized by processes by the CPU 901, and stores various data in the storage unit 99 and reads various data from the storage unit 99.

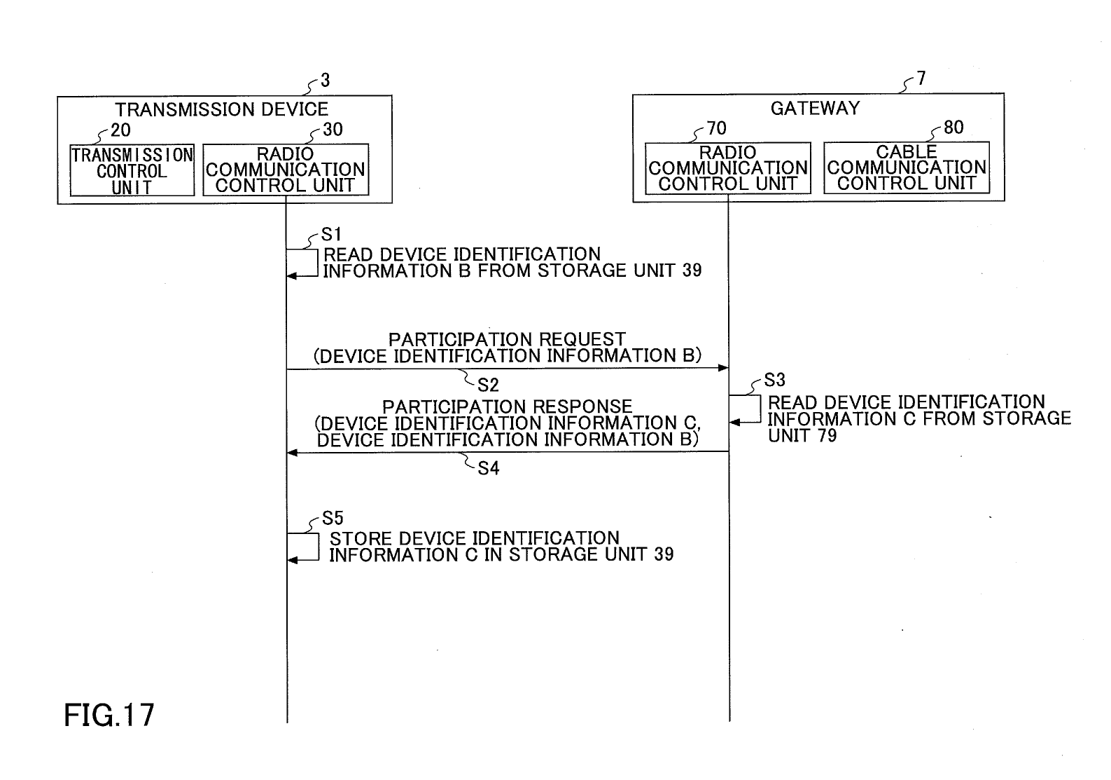

Next, with reference to FIGS. 17 through 25, a description is given of operations of the position management system 1.

First, with reference to FIG. 17, a description is given of a process of constructing a communication network on the ceiling β of the indoor location α. Note that FIG. 17 is a sequence diagram indicating a process of constructing a communication network on the ceiling.

First, when the user turns on the power of the electrical devices 2 in the indoor location α, the storing/reading unit 38 in the radio communication control unit 30 in each of the transmission devices 3 (see FIG. 14) reads the respective device identification information B from each of the storage units 39 (step S1). Then, each sending/receiving unit 31 sends a participation request including the device identification information B of itself, to the gateway 7 (step S2). Accordingly, the sending/receiving unit 71 in the radio communication control unit 70 in the gateway 7 receives the participation request.

Next, the storing/reading unit 78 of the radio communication control unit 70 reads device identification information C from the storage unit 79 (step S3). Then, the sending/receiving unit 71 sends, to the transmission device 3, a participation response including the device identification information (B, C) (step S4). Accordingly, the sending/receiving unit 31 in the radio communication control unit 30 of the transmission device 3 receives the participation response. In this case, the participation response includes the device identification information B sent in step S2 described above, and therefore the radio communication control unit 30 performs the receiving process of step S4 described above, as a process relevant to step S2 described above. Then, the storing/reading unit 38 stores the device identification information C in the storage unit 39 (step S5). As described above, the transmission device 3 side stores the device identification information C of the gateway 7, and therefore a communication network between the transmission device 3 and the gateway 7 is constructed.

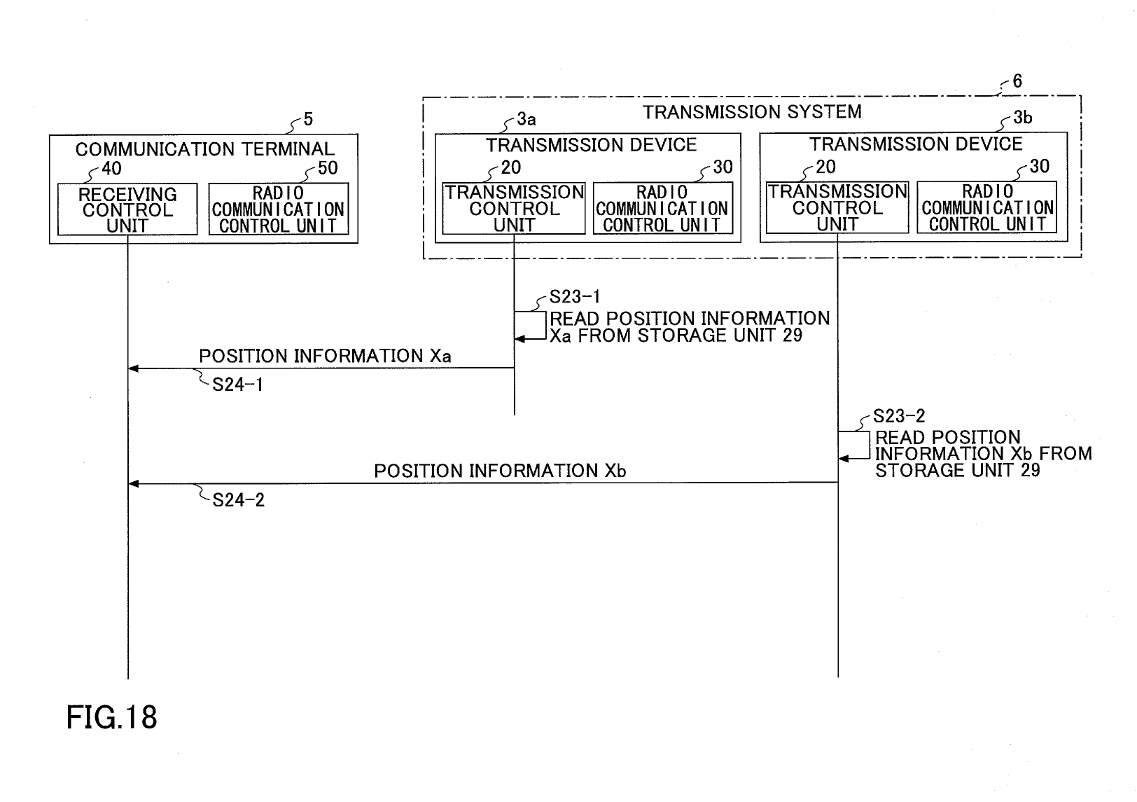

Next, with reference to FIG. 18, a description is given of a process of transmitting position information in a direction from the transmission device 3 on the ceiling β to the floor in the indoor location α illustrated in FIG. 1. Note that FIG. 18 is a sequence diagram illustrating a process of transmitting position information. In FIG. 18, as a matter of simplification, a description is given of a case of using a transmission system 6 constructed by two transmission devices (3a, 3b). In this case, the transmission device 3a transmits position information Xa, and the transmission device 3b transmits position information Xb. Furthermore, in the case of FIG. 18, the communication terminal 5 is present in a range where the transmission devices (3a, 3b) can transmit the position information (Xa, Xb), respectively.

First, the storing/reading unit 28 in the transmission control unit 20 in the transmission device 3a reads the position information Xa of itself from the storage unit 29 (step S23-1). Then, the transmission unit 21 in the transmission control unit 20 in the transmission device 3a transmits the position information Xa to a range where transmission is possible (step S24-1). Similarly, the storing/reading unit 28 in the transmission control unit 20 of the transmission device 3b reads the position information Xb of itself from the storage unit 29 (step S23-2). Then, the transmission unit 21 in the transmission control unit 20 in the transmission device 3b transmits the position information Xb to a range where transmission is possible (step S24-2). Note that even when the position information (Xa, Xb) is transmitted, if the receiving unit 41 in the communication terminal 5 is not started up, the position information (Xa, Xb) cannot be received.

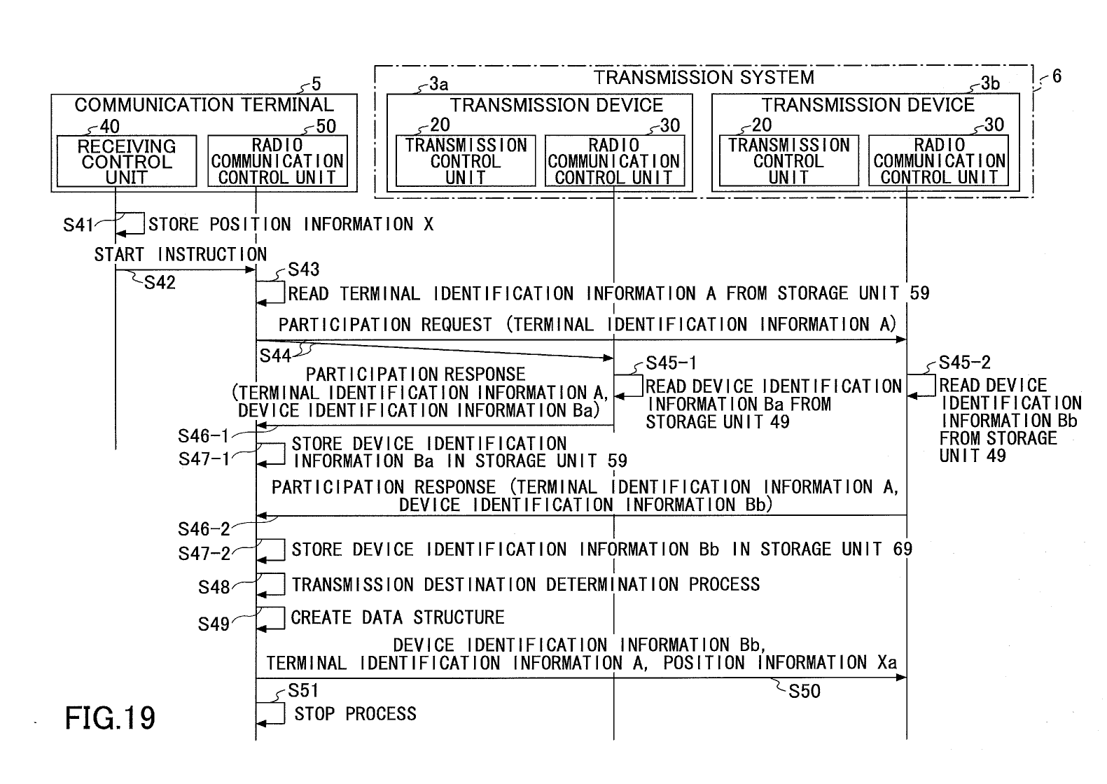

Next, with reference to FIG. 19, a description is given of a process of determining the position information X to be used by the communication terminal 5, and determining the transmission device 3 to be the transmission destination of the position information X. Note that FIG. 19 is a sequence diagram illustrating a process of determining the position information X to be used by the communication terminal 5, and determining the transmission device 3 to be the transmission destination of the position information X. FIG. 19 illustrates a case where the communication terminal 5 receives the position information Xa from the transmission device 3a, and this position information Xa is sent to the transmission device 3b and not the transmission device 3a.

First, as illustrated in FIG. 19, the storing/reading unit 48 in the receiving control unit 40 of the communication terminal 5 stores, in the storage unit 49, the position information having the higher signal intensity when received at the communication terminal 5, between the position information Xa transmitted from the transmission device 3a and the position information Xb transmitted from the transmission device 3b (step S41). Accordingly, the position indicated by the stored position information X is managed later by the position information management system 9 as the position of the communication terminal 5.

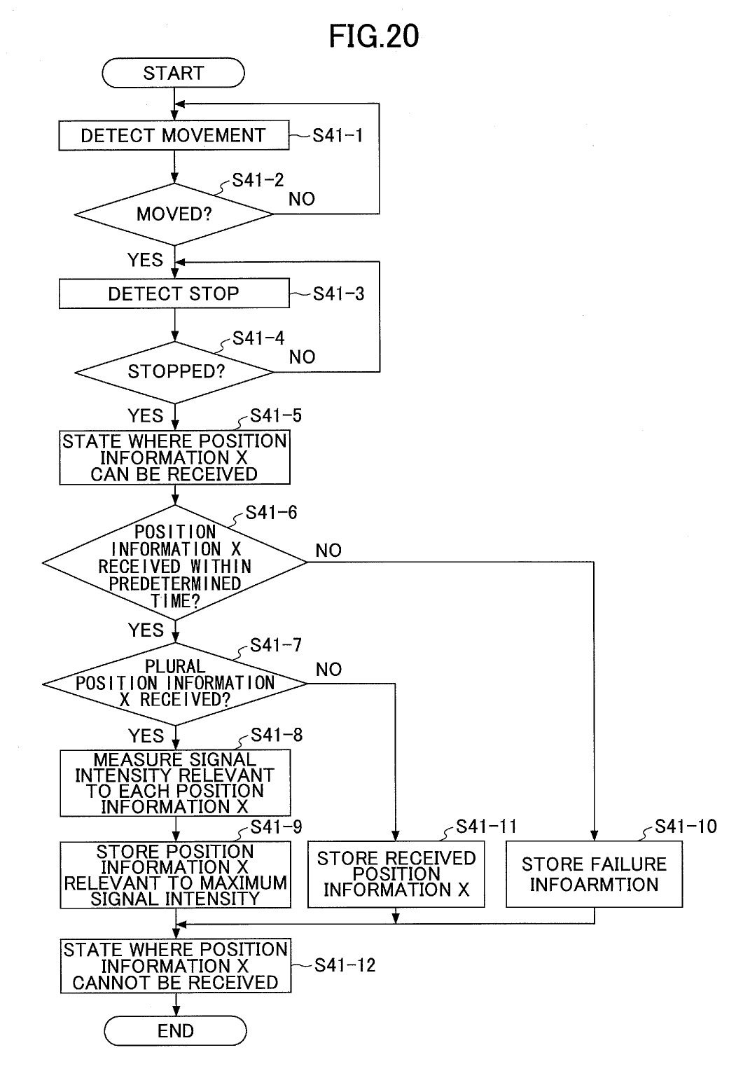

With respect to step S41 described above, a more detailed description is given with reference to FIG. 20. Note that FIG. 20 is a flowchart of a process performed from when the communication terminal 5 receives position information to when the communication terminal 5 stores the position information.

First, the detecting unit 42 in the receiving control unit 40 in the communication terminal 5 continuously monitors the communication terminal 5 until the start of the movement of the communication terminal 5 can be detected (step S41-1, No in step S41-2). Then, when the detecting unit 42 detects the start of the movement of the communication terminal 5 (YES in step S41-2), the detecting unit 42 continuously monitors the communication terminal 5 until the stop of the movement of the communication terminal 5 can be detected (step S41-3, NO in step S41-4). More specifically, when the process of the CPU 401 illustrated in FIG. 7 is stopped, and the acceleration sensor 405 detects a change in the acceleration of the communication terminal 5, the acceleration sensor 405 sends, to the CPU 401, a signal indicating that the communication terminal 5 has started moving (to start the processing of the CPU 401). Then, the CPU 401 starts its own processing and maintains a processing state, until a signal indicating that the communication terminal 5 has stopped moving is received from the acceleration sensor 405. Note that in this case, the movement of the communication terminal 5 includes a case where the communication terminal 5 is tilted.

Next, in step S41-4 described above, when the detecting unit 42 detects that the communication terminal 5 has stopped moving (YES in step S41-4), the receiving unit 41 turns into a state where position information X transmitted by the transmission device 3 can be received (step S41-5). More specifically, when the CPU 401 illustrated in FIG. 7 receives a signal indicating that the communication terminal 5 has stopped moving from the acceleration sensor 405, the CPU 401 sends, to the communication circuit 404, a signal for causing the communication circuit 404 to start processing. Accordingly, the communication circuit 404 starts its own processing. In this case, when the transmission devices (3a, 3b) are respectively transmitting position information (Xa, Xb), the communication circuit 404 in the control unit 14 in the communication terminal 5 can start receiving the position information (Xa, Xb) via the antenna 404a.

Next, the determining unit 43 determines whether at least one piece of position information X has been received within a predetermined time (for example, within five seconds), after the receiving unit 41 turns into a state where the position information X can be received (step S41-6). In this case, a description is given of a case where two pieces of position information (Xa, Xb) are received within a predetermined time.

Furthermore, in step S41-6 described above, when the determining unit 43 determines that at least one piece of position information X has been received (YES), furthermore, the determining unit 43 determines whether a plurality of pieces of position information X have been received (step S41-7).

Next, in step S41-7, when the determining unit 43 determines that a plurality of pieces of position information X have been received (YES), the measuring unit 44 measures the signal intensity of each position information X received by the receiving unit 41 (step S41-8). A further description is given of a case where the signal intensity of the position information Xa is higher than the signal intensity of the position information Xb, as a result of the measurement.

Next, the storing/reading unit 48 stores, in the storage unit 49, the position information X having the highest signal intensity, according to the measurement of step S41-8 described above (step S41-9). In this case, the position information Xa is stored.

Meanwhile, in step S41-6 described above, when the determining unit 43 determines that at least one piece of position information X is not received within a predetermined time (NO), the storing/reading unit 48 stores, in the storage unit 49, failure information indicating that the receiving has failed (step S41-10).

Furthermore, in step S41-7, when the determining unit 43 determines that a plurality of pieces of position information X have not been received within a predetermined time (NO), the storing/reading unit 48 stores the only piece of position information X that has been received (step S41-11).

Then, after the processes of steps S41-9, 10, and 11 described above, the receiving unit 41 stops processing, so that the position information X cannot be received (step S41-12). More specifically, the CPU 401 illustrated in FIG. 7 sends, to the communication circuit 404, a signal for stopping the process of the communication circuit 404. Accordingly, after the communication terminal 5 moves, only when the communication terminal 5 stops, the process of receiving the position information X is performed. Therefore, even when a battery having low capacity such as the button battery 406 is used, the frequency of replacing the battery can be reduced, thereby contributing to power-saving.

Note that in the above case, after the communication terminal 5 starts moving (YES in step S41-2), when the communication terminal 5 stops moving (YES in step S41-4), the receiving unit 41 turns into a state where the position information X can be received (step S41-5). That is to say, when both the starting of the movement and the stopping of the movement are performed, a trigger is implemented for turning the receiving unit 41 into a state where position information X can be received. However, the trigger is not so limited. For example, the starting of the movement of the communication terminal 5 (YES in step S41-2) may trigger the receiving unit 41 to turn into a state where position information X can be received. That is to say, omitting steps S41-3 and 4 described above and starting the movement may trigger the receiving unit 41 to turn into a state where position information X can be received. Furthermore, for example, omitting steps S41-1 and 2 described above and stopping the movement may trigger the receiving unit 41 to turn into a state where position information X can be received.

Next, referring back to FIG. 19, the communication unit 47 of the receiving control unit 40 gives an instruction to start operating to the radio communication control unit 50 (step S42). Accordingly, the communication unit 57 in the radio communication control unit 50 receives an instruction to start operating, and starts the process described below.

First, the storing/reading unit 58 in the radio communication control unit 50 in the communication terminal 5 reads the terminal identification information A of itself from the storage unit 59 (step S43). Then, the sending/receiving unit 51 sends a participation request including the terminal identification information A, to the transmission devices (3a, 3b) (step S44). Accordingly, the transmission devices (3a, 3b) respectively receive a participation request from the communication terminal 5.

Next, the storing/reading unit 38 in the radio communication control unit 30 in the transmission device 3a reads device identification information Ba of itself from the storage unit 39 (step S45-1). Then, the sending/receiving unit 31 in the transmission device 3a sends a participation response including the terminal identification information A and the device identification information Ba, to the communication terminal 5 (step S46-1). Accordingly, the sending/receiving unit 51 in the radio communication control unit 50 in the communication terminal 5 receives a participation response. In this case, the participation response includes the terminal identification information A sent in step S44 described above, and therefore the communication terminal 5 performs the reception process of step S46-1 described above, as a process relevant to step S44 described above. Then, the storing/reading unit 58 in the radio communication control unit 50 in the communication terminal 5 stores the device identification information Ba in the storage unit 59 (step S47-1).

Meanwhile, similarly on the transmission device 3b side, the storing/reading unit 38 in the radio communication control unit 30 in the transmission device 3b reads the device identification information Bb of itself from the storage unit 39 (step S45-2). Furthermore, the sending/receiving unit 31 of the transmission device 3b sends a participation response including the terminal identification A and the device identification information Bb to the communication terminal 5 (step S46-2). Accordingly, the sending/receiving unit 51 in the radio communication control unit 50 in the communication terminal 5 receives the participation response. Then, the storing/reading unit 58 in the radio communication control unit 50 in the communication terminal 5 stores the device identification information Bb in the storage unit 59 (step S47-2).

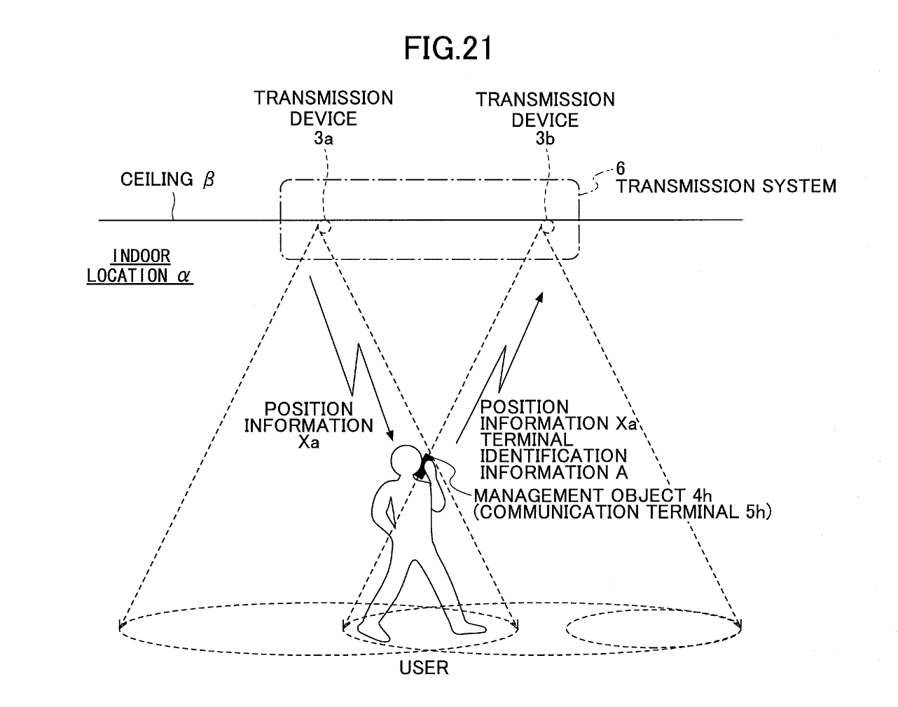

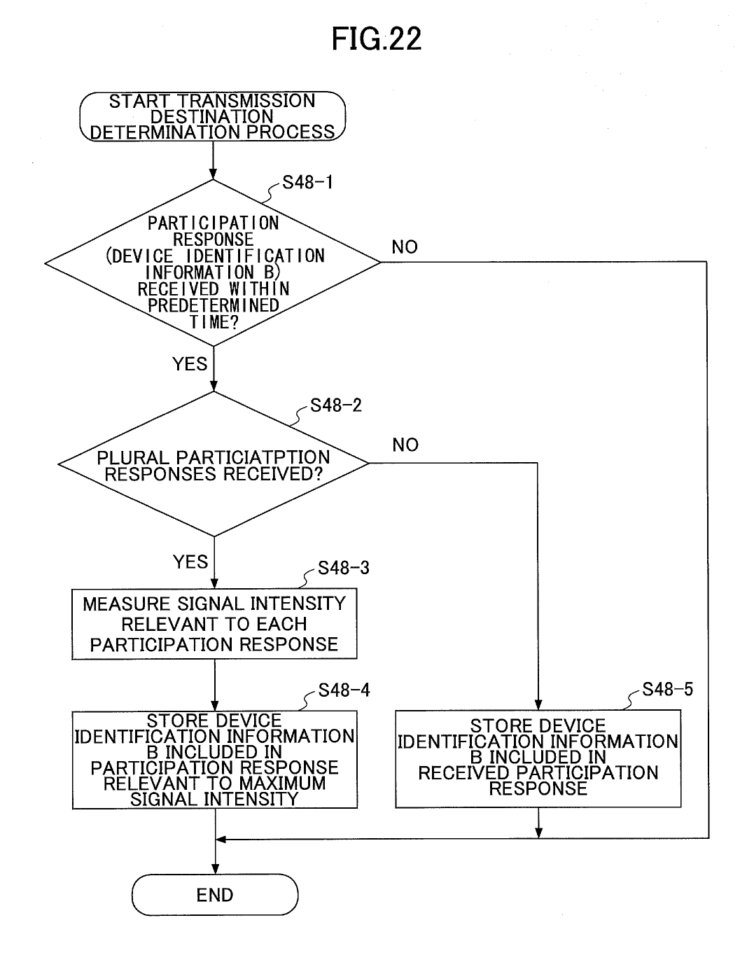

Next, the radio communication control unit 50 performs a process of determining the transmission device 3 to be the transmission destination of the position information X received from the transmission device 3 and the terminal identification information A of itself (step S48). Before giving a detailed description of the process of step S48 with reference to FIG. 22, a description is given of the background of the process of step S48, with reference to FIGS. 5, 14, and 21. Note that FIG. 21 is a pictorial diagram indicating the communication status between the transmission device 3 and the communication terminal 5.

As illustrated in FIG. 14, the communication between the transmission control unit 20 in the transmission device 3 and the receiving control unit 40 in the communication terminal 5 is separate from the communication between the radio communication control unit 30 in the transmission device 3 and the radio communication control unit 50 in the communication terminal 5. Furthermore, while the receiving control unit 40 receives the position information X from the transmission device 3 that is the transmission source, the radio communication control unit 50 returns the position information X and the terminal identification information A of itself to the transmission device 3.

However, if a transmission control unit 20 and a radio communication control unit 30 are provided in all of the transmission devices 3, the installation cost becomes significantly high in a case where the floor area of the indoor location α is large and multiple transmission devices 3 are installed (pattern 1).

Furthermore, there are cases where the transmission device 3a can transmit the position information Xa, but the radio communication control unit 30 of the transmission device 3a is broken down, and therefore the transmission device 3a cannot receive the terminal identification information A or the position information Xa from the communication terminal 5 (pattern 2).

Furthermore, when a plurality of transmission devices 3 are installed on the ceiling β, depending on the position of the communication terminal 5 in the indoor location α, there may be cases where even though the signal intensity of the data of the position information X received from the transmission control unit 20 of the transmission device 3a (see step S24-1) is higher than that of the transmission control unit 20 of the transmission device 3b (see step S24-2), the signal intensity of the data of the participation response received from the radio communication control unit 30 of the transmission device 3b (step S46-2) is higher than that of the radio communication control unit 30 of the transmission device 3a (step S46-1) (pattern 3).

In the above patterns 1 through 3, as illustrated in FIG. 21, the communication terminal 5h receives position information Xa from the transmission device 3a that is the transmission source, but sends the position information Xa together with the terminal identification information A of itself to the transmission device 3b that is a transmission destination different from the transmission device 3a. In the following, with reference to FIGS. 14 through 20, a description is given of an example where the transmission source and the transmission destination are different, as described above. Note that FIG. 22 is a flowchart indicating a process of determining the transmission destination.

The determining unit 53 in the radio communication control unit 50 in the communication terminal 5 illustrated in FIG. 14 determines whether the sending/receiving unit 51 has received at least one participation response within a predetermined time (for example, within five seconds) from when the sending/receiving unit 51 has sent a participation request to the respective transmission devices (3a, 3b) in step S44 described above (step S48-1). That is to say, the determining unit 53 determines whether at least one piece of device identification information B has been received within a predetermined time from when the sending of the terminal identification information A has started.

Next, in step S48-1 described above, when the determining unit 53 determines that at least one participation response has been received (YES), furthermore, the determining unit 53 determines whether a plurality of participation responses have been received (step S48-2). That is to say, the determining unit 53 determines whether a plurality of pieces of device identification information B have been received within a predetermined time from when the sending of the terminal identification information A has started.

Next, in step S48-2 described above, when the determining unit 53 determines that a plurality of participation responses have been received (YES), the measuring unit 54 measures the signal intensity relevant to the participation response when received by the sending/receiving unit 51 (step S48-3). In this case, in steps S46-1, 2 described above, the radio communication control unit 50 in the communication terminal 5 receives the participation responses from the transmission devices (3a, 3b), and therefore the process of step S48-3 is executed.

Next, a description is given of a case where the signal intensity of the participation response from the transmission device 3b is higher than the signal intensity of the participation response from the transmission device 3a, as a result of the measurement by the process at step S48-3 described above. As illustrated in FIG. 22, the storing/reading unit 58 stores, in the storage unit 59, the device identification information B (device identification information Bb in this case) included in the participation response having the highest signal intensity among the signal intensities measured in step S48-3 described above (step S48-4).

Note that in step S48-1, when the determining unit 53 determines that at least one participation response is not received within a predetermined time (NO), the process of determining a transmission destination ends. Furthermore, in step S48-2, when the determining unit 53 determines that a plurality of participation responses are not received (NO), the storing/reading unit 58 stores, in the storage unit 59, the device identification information B included in the only participation response that is received (step S48-5).

As described above, the transmission device 3 that is indicated by the device identification information B stored in the storing/reading unit 58, is determined as the transmission destination of the communication terminal 5.

Then, after the processes of steps S48-4, 5 described above, the sending/receiving unit 51 creates a data structure of information as illustrated in FIG. 9, for the transmission destination determined in step S48 described above (step S49). In this case, in the data structure, the device identification information Bb of the transmission device 3b that is the transmission destination, the terminal identification information Ah of the communication terminal 5h that is the transmission source, and the data contents (in this case, the position information Xa of the transmission device 3a that is the transmission source), are arranged in this order.

Next, the sending/receiving unit 51 sends the information of the data structure created in step S49, to the transmission device 3b (step S50). Accordingly, the radio communication control unit 30 of the transmission device 3b receives the information sent from the communication terminal 5h.

Then, at the communication terminal 5h, the sending/receiving unit 51, the determining unit 53, the measuring unit 54, the communication unit 57, and the storing/reading unit 58 in the radio communication control unit 50 stops the processing (step S51). As described above, when the sending/receiving unit 51 finishes sending information such as the position information X to the transmission device 3, the processes of the respective units in the radio communication control unit 50 are stopped, and therefore power-saving can be realized. Note that the respective units in the radio communication control unit 50 may be started up again by receiving a new start instruction from the receiving control unit 40 in step S42 described above.

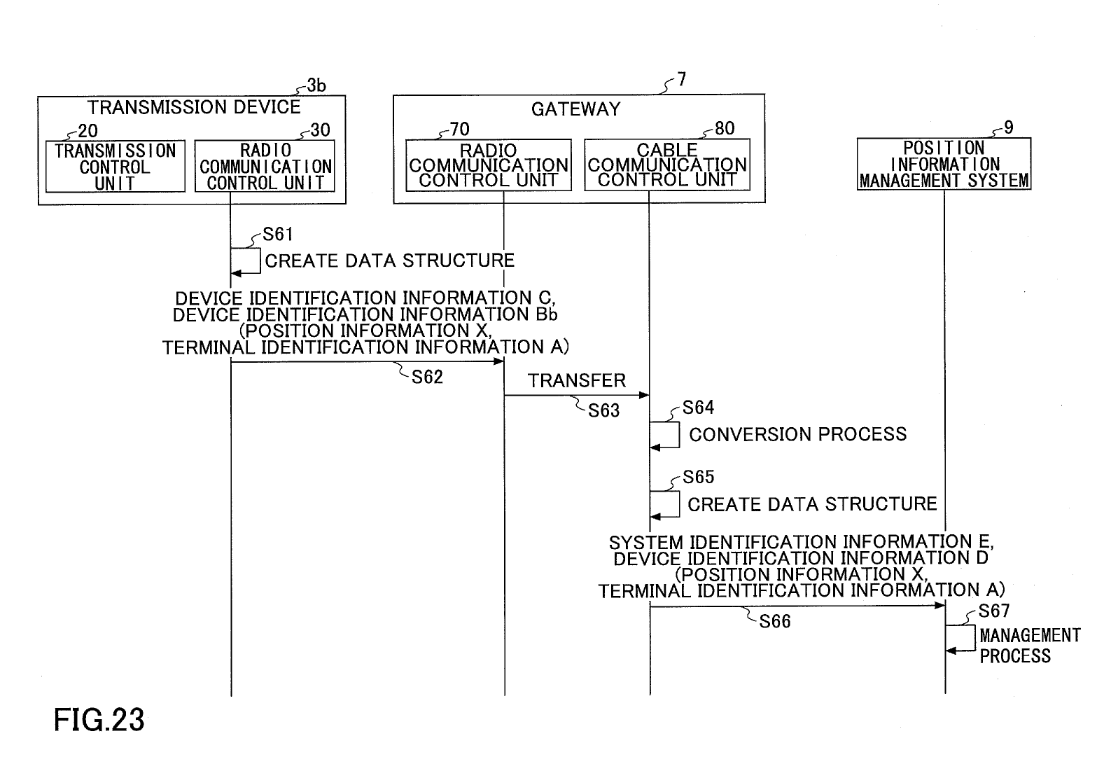

Next, with reference to FIG. 23, a description is given of a process from when information including the position information X is received at the transmission device 3 to when the information is managed as management information F in the position information management system 9. Note that FIG. 23 is a sequence diagram illustrating a process of managing position information.

As illustrated in FIG. 23, first, as in the process of step S49 described above, the radio communication control unit 30 in the transmission device 3b creates a data structure of information to be sent to the gateway 7 (step S61). In this case, in the data structure, the device identification information C of the gateway 7 that is the transmission destination, the device identification information Bb of the transmission device 3b that is the transmission source, and the data contents (the position information Xa of the transmission device 3a that is the transmission source and the terminal identification information A of the communication terminal 5 that is the transmission source of the position information Xa), are arranged in this order.

Next, the sending/receiving unit 31 in the radio communication control unit 30 in the transmission device 3b sends, to the gateway 7, the information of the data structure created in step S61 described above (step S62). Accordingly, the sending/receiving unit 71 in the radio communication control unit 70 in the gateway 7 receives the information sent from the transmission device 3b.

Next, the communication unit 77 in the radio communication control unit 70 similarly transfers, to the communication unit 87 in the gateway 7, the information received in step S62 described above (step S63). Accordingly, the cable communication control unit 80 receives the information transferred from the radio communication control unit 70.

Next, the conversion unit 82 in the cable communication control unit 80 converts a communication method complying with IEEE802.15.4 into a communication method complying with IEEE802.3, and implements control so that the information sent from the transmission device 3b can be used for packet communication of Ethernet (registered trademark) (step S64). Then, as in the process of step S61 described above, the sending/receiving unit 81 in the cable communication control unit 80 creates a data structure of information to be sent to the position information management system 9 (step S65). In this case, in the data structure, system identification information E of the position information management system 9 that is the transmission destination, device identification information D of the gateway 7 that is the transmission source, and data contents (the position information Xa of the transmission device 3a that is the transmission source and the terminal identification information A of the communication terminal 5 that is the transmission source of the position information Xa), are arranged in this order.

Next, the sending/receiving unit 81 in the cable communication control unit 80 in the gateway 7 sends, to the position information management system 9, the information having the data structure as created in step S65 described above (step S66). Accordingly, the sending/receiving unit 91 in the position information management system 9 receives the information sent from the gateway 7.

Next, the storing/reading unit 98 of the position information management system 9 associates the information of the reception date when the position information X is received and the position information Xa, with the terminal identification information A stored in advance in the storage unit 99, and stores this information as management information F as illustrated in FIG. 13, thereby performing a process of managing position information (step S67).

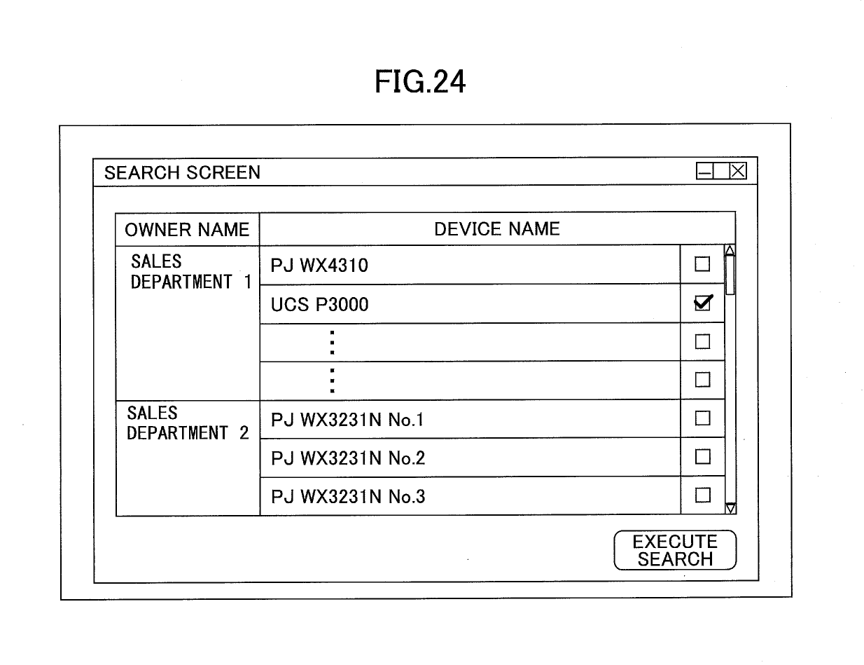

As described above, the position information management system 9 manages the management information F, and therefore an administrator of the position information management system 9 can perform a search as illustrated in FIGS. 24 and 25. Note that FIGS. 24 and 25 illustrate screen examples in the position information management system 9.

For example, when the administrator operates the keyboard 911 and the mouse 912 illustrated in FIG. 12, the operation input receiving unit 92 receives an operation input, the display control unit 94 reads the management information F via the storing/reading unit 98, and displays a search screen as illustrated in FIG. 24, on the display 908. In this search screen, a search list is displayed, which includes a device name indicated for each owner name (or administrator name). Furthermore, on the right of the device names, tick boxes are displayed. Furthermore, at the bottom right of the search list, an “execute search” button for executing the search is displayed. Note that in the search screen illustrated in FIG. 24, an example of searching for the position of a device “UCS P3000” owned by an owner “sales department 1” is displayed.

Then, by operating the keyboard 911 and the mouse 912, the administrator inputs a tick mark in the tick box corresponding to the device name of the device (management object 4) of which the administrator wants to know the position. Then, the operation input receiving unit 92 receives the input of the tick mark. Then, after the administrator has input a tick mark in the tick box of the device name of all devices of which the administrator wants to know the position, the administrator presses the “execute search” button. Accordingly, the operation input receiving unit 92 receives the request to execute the search, and the searching unit 93 searches the management information F stored in the storage unit 99 based on the device names to which tick marks have been applied, and extracts part of the management information F including the corresponding position information X and the layout information G indicating the floor including the position relevant to this position information X.

Then, the display control unit 94 displays a search result screen as illustrated in FIG. 25 on the display 908, based on the management information F and the layout information G. This search result screen indicates the layout diagram of the floor “building A fourth floor” where the device “UCS P3000” is positioned, and the position information X and various information items such as the reception date in the management information F. Accordingly, the administrator can visually recognize the position of the management object 4 (communication terminal 5).

As described above, according to the present embodiment, the transmission device 3 includes not only the transmission unit 21 but also the sending/receiving unit 31. That is to say, the communication terminal 5, which is present in a range where the position information X transmitted by the transmission device 3 can reach, only needs to send the position information X and the terminal identification information A to the transmission device 3 in this range. Therefore, only a minimum amount of power needs to be consumed for the transmission. Thus, the transmission device 3 can contribute to power-saving of the communication terminal 5.

Furthermore, only when the communication terminal 5 stops moving after the communication terminal 5 starts to move, the process of receiving the position information X is started, and therefore the consumption of battery capacity can be mitigated, which contributes to power saving. Furthermore, when the sending/receiving unit 51 finishes sending information such as position information X to the transmission device 3, the processes of the respective units in the radio communication control unit 50 are stopped, and therefore power-saving can be realized. Note that by contributing to power saving, even when a battery having low capacity such as the button battery 406 is used, the frequency of replacing battery can be reduced, and therefore the user is saved of the trouble of frequently replacing the battery.

Furthermore, as illustrated in FIG. 21, instead of the transmission device 3a, the transmission device 3b can receive the position information Xa and the terminal identification information A from the communication terminal 5, and therefore the installation cost of the transmission device 3 can be suppressed (corresponding to pattern 1 described above). Furthermore, even if the radio communication control unit 30 breaks down, the transmission system 6 can acquire position information Xa and the terminal identification information A from the communication terminal 5 (corresponding to pattern 2 described above). Furthermore, the communication terminal 5 can send the position information X and the terminal identification information A to the transmission device 3 that can perform communications by high signal intensity, and therefore the transmission system 6 can receive the position information X and the terminal identification information A from the communication terminal 5 more reliably (corresponding to pattern 3 described above).

Note that the position information management system 9 may be constructed by a single computer. Alternatively, the respective units (functions, means, or storage units) may be divided and arbitrarily assigned to a plurality of computers, and the position information management system 9 may be constructed by these plurality of computers.

Furthermore, a recording medium such as a CD-ROM storing the programs according to the above embodiment, and a hard disk storing these programs, may be provided in home or abroad as a program product.

Furthermore, the determining unit 63, which is a specific example of a first determining unit, may include the determining unit 53, which is a specific example of a second determining unit. That is to say, the first determining unit and the second determining unit may be the same unit or different units. Similarly, the measuring unit 64, which is a specific example of a first measuring unit, may include the measuring unit 67, which is a specific example of a second measuring unit. That is to say, the first measuring unit and the second measuring unit may be the same unit or different units.

### Description of Position Information Management System According to an Embodiment of Present Invention

As described above, the position information management system 9 constituting the position management system 1 receives position information X and terminal identification information A from one or more communication terminals 5 (or management objects 4) via one or more transmission devices 3 (or electrical devices 2), and manages these information items. As described above, each communication terminal 5 can receive, at arbitrary timings, the position information transmitted from the transmission device 3 according to an IMES specification, etc.

Meanwhile, the communication terminal 5 in the position management system 1 according to an embodiment of the present invention described below, is configured to send the position information X and terminal identification information A to the transmission device 3 at a timing when the movement of the communication terminal 5 is detected. The communication terminal 5 can detect whether the communication terminal 5 itself has been physically moved, according to the functions of the acceleration sensor 405 (see FIG. 7) and the detecting unit 42 (see FIG. 14) included in the communication terminal 5. Furthermore, the communication terminal 5 can store the position information X received in the past, according to the function of the ROM 402 or the RAM 403 (see FIG. 7) and the storage unit 49 (see FIG. 14).

The transmission device 3 sends, to the position information management system 9, the position information X and terminal identification information A sent as described above, by the same procedures as those described with reference to FIG. 23. Then, the position information management system 9 associates these information items with other information (device name or owner name, etc., indicated as examples in FIG. 13), and stores the associated information.

In addition to the information indicated in FIG. 13, the position information management system 9 of the position management system 1 can further store, as management information F, information of the “reception frequency” of receiving the position information from the communication terminal 5 and the “drive time” of the communication terminal 5. The position information management system 9 uses the information of the “reception frequency” and the “drive time” to calculate the possible drive time of each communication terminal 5. Then, when the remaining amount becomes less than a certain value, a notification indicating that the battery needs to be replaced can be sent to the administrator.

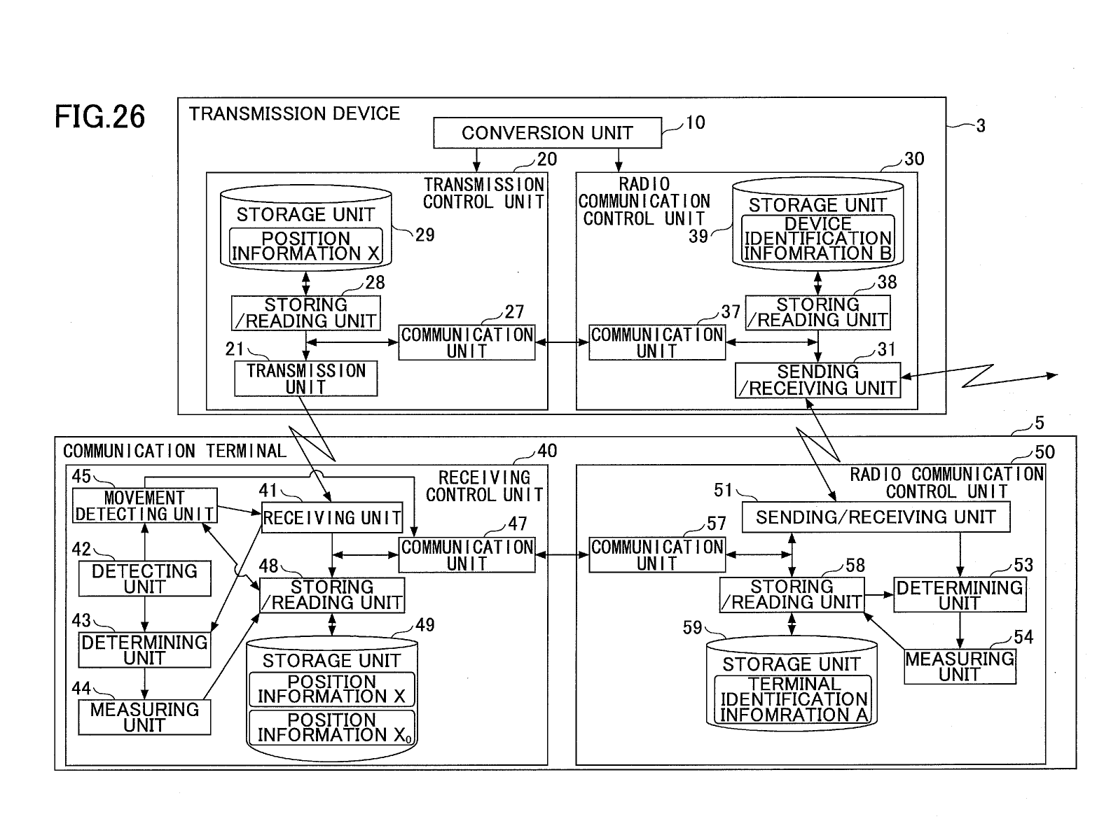

In the following, with reference to FIGS. 26 through 32, a detailed description is given of the position management system 1 according to an embodiment of the present invention.

### Hardware Configuration

First, a description is given of the hardware of devices constituting the position management system 1 according to an embodiment of the present invention.

The transmission device 3 in the position management system 1 is built in, for example, the LED lamp 130 as described with reference to FIG. 5. The configurations of the devices in the transmission device 3 are the same as those of FIG. 5.

The communication terminal 5 in the position management system 1 is provided, for example, by being attached to the management object 4, as described with reference to FIGS. 3 and 7, and is mainly driven by a battery. The configurations of the devices in the communication terminal 5 are the same as that of FIG. 7. Furthermore, the communication terminal 5 may be the management object itself, such as the mobile phone illustrated in FIG. 10. In this case, the configurations of the devices included in the communication terminal 5 are the same as those of FIG. 10.

The gateway 7 in the position management system 1 is a device provided at the boundary between the network to which the transmission device 3 belongs and the network to which the position information management system 9 belongs. The configurations of the devices in the gateway 7 are the same as those of FIG. 11.

The position information management system 9 in the position management system 1 is at least one computer managing the position information of each communication terminal 5. The configurations of the devices in the position information management system 9 are the same as those of FIG. 12.

### Description of Functional Blocks

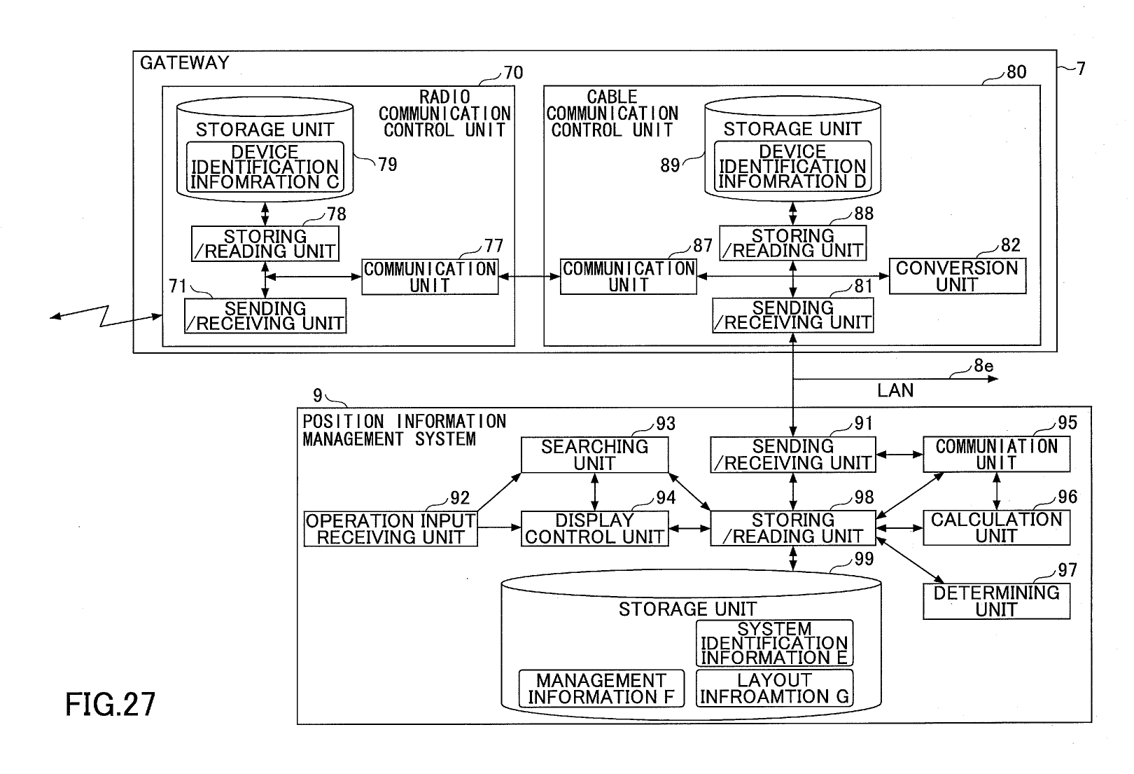

Next, with reference to FIGS. 26 and 27, a description is given of functional blocks of the devices constituting the position management system 1 according to an embodiment of the present invention.

FIG. 26 is a functional block diagram of the transmission device 3 and the communication terminal 5 according to an embodiment of the present invention. The respective functions of the transmission device 3 are the same as those of FIG. 14, and therefore descriptions thereof are omitted. In the following, among the functional configurations of the communication terminal 5, functions that are different from those of FIG. 14 are mainly described.

As described with reference to FIG. 14, the communication terminal 5 includes, as a function or a unit, the receiving control unit 40 and the radio communication control unit 50.

The receiving control unit 40 includes a storage unit 49 constructed by the RAM 403 illustrated in FIG. 7. The storage unit 49 may store the present position information X and the past position information X₀, transmitted from the transmission device 3. The number of stored pieces of past position information X₀ is arbitrary; in the following description, as a matter of simplification, X₀ expresses one piece of position information (that is to say, X₀ expresses the last position information).

The receiving control unit 40 includes a movement detecting unit 45, in addition to the functions illustrated in FIG. 14.

The movement detecting unit 45 is mainly realized by processes by the CPU (101, 201) illustrated in FIG. 5. The movement detecting unit 45 recognizes the change in the acceleration detected by the detecting unit 42, and when the acceleration stops changing after the acceleration starts changing (for example, when a predetermined time elapses after the change in the acceleration cannot be detected any more), the movement detecting unit 45 determines that the physical movement of the communication terminal 5 has been made. In this case, the movement detecting unit 45 stores, by the storing/reading unit 48, the position information X stored in the storage unit 49 as position information X₀.

When the communication terminal 5 is physically moved, the movement detecting unit 45 causes the receiving unit 41 to receive new position information. The received position information is stored as position information X in the storage unit 49, by the storing/reading unit 48.

Subsequently, the movement detecting unit 45 compares the position information X and the position information X₀, and when these information items do not match, the movement detecting unit 45 determines that the communication terminal 5 has been moved. As described above, when the movement detecting unit 45 detects the movement of the communication terminal 5, as described with reference to FIG. 19, the communication unit 47 of the receiving control unit 40 gives an instruction to start operations to the radio communication control unit 50. Then, the present position information X and the terminal identification information A of the communication terminal 5 are sent to the transmission device 3.

Furthermore, while the detecting unit 42 is detecting the change in the acceleration (that is to say, from when the acceleration starts changing until before the acceleration stops changing), the movement detecting unit 45 may cause the receiving unit 41 to receive new position information. In this case, when the received position information X expresses a particular position that is already known, the present position information X and the terminal identification information A of the communication terminal 5 may be sent to the transmission device 3, without performing the comparing process described above. A particular position is, for example, the position of the transmission device 3 installed at the entrance of the building. For this purpose, a list of position information items expressing particular positions is stored in advance in the storage unit 49 of the communication terminal 5. Such a particular position is useful in a case where the user desires to recognize the time point when the communication terminal 5 enters the building.

Note that the receiving unit 41 in the communication terminal 5 according to the present embodiment may receive positioning signals, when positioning signals can be received from the GPS satellite. In this case, a positioning unit (not shown) in the communication terminal 5 performs positioning with the use of the positioning signals that can be received from a plurality of GPS satellites. Then, the communication terminal 5 may send the position information (latitude, longitude) obtained by the positioning, to the position information management system 9, through a radio network such as the mobile body communication network 8b.

Furthermore, when the corresponding communication terminal 5 is activated, the receiving unit 41 of the communication terminal 5 may be configured to receive the position information transmitted from the transmission device 3, and the sending/receiving unit 51 may be configured to send the received position information and the terminal identification information A to the transmission device 3.

FIG. 27 is a functional block diagram of the gateway 7 and the position information management system 9 according to an embodiment of the present invention. The functions of the gateway 7 are the same as those illustrated in FIG. 16, and therefore descriptions thereof are omitted. In the following, among the functional configurations of the position information management system 9, functions that are different from those of FIG. 16 are mainly described.

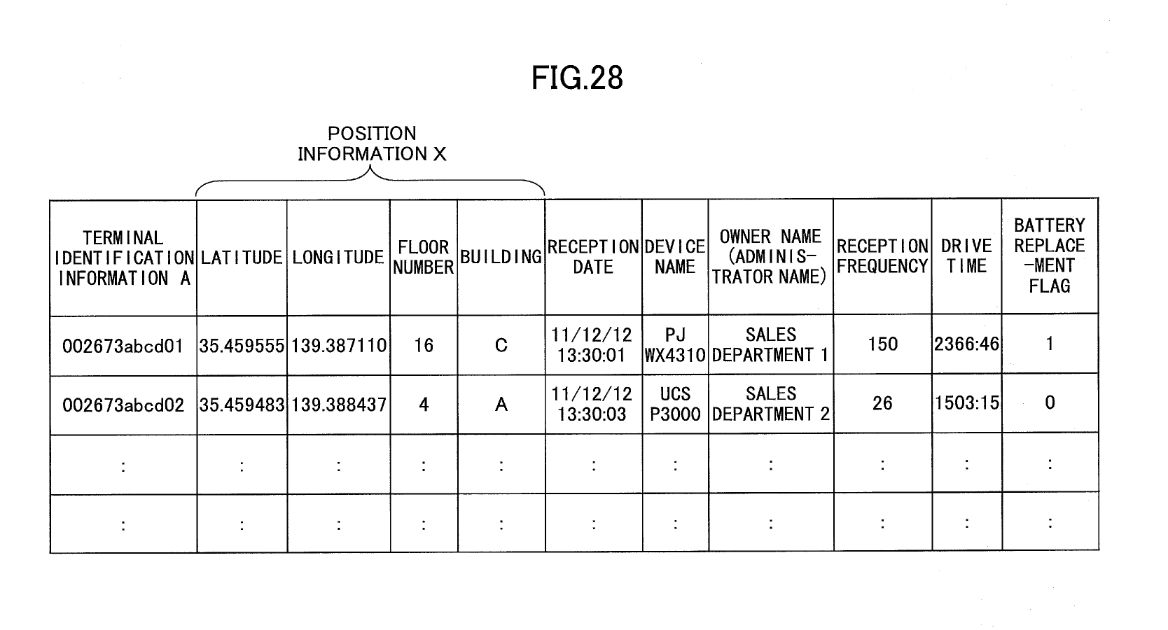

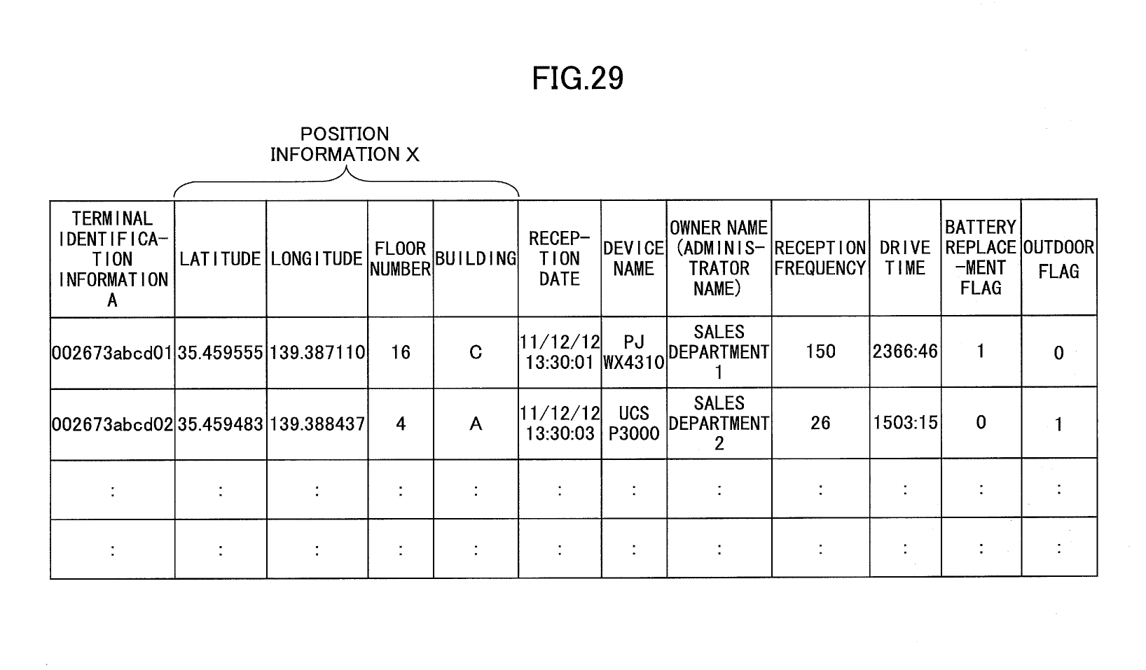

The position information management system 9 includes the storage unit 99 constructed by the RAM 903 and the HD 904 illustrated in FIG. 12. The storage unit 99 stores the system identification information E, the management information F, and the layout information G described above. In this case, the management information F according to the present embodiment is different from that indicated in FIG. 13, and includes the items indicated in FIG. 28 or FIG. 29.

The management information F illustrated in FIG. 28 further includes, in addition to the items indicated in FIG. 13, the items of “reception frequency”, the “drive time”, and a “battery replacement flag”, which are associated with each communication terminal 5 and stored. The contents of each of the items are described below.
Reception frequency: The number of times the position information X (and terminal identification information A) is received from the communication terminal 5. When the position information X is received, this number is incremented by one. When the battery of the communication terminal 5 is replaced or fully charged, this number is reset to “0”.
Drive time: The drive time from when the battery of the communication terminal 5 is replaced or fully charged, to the present time. The format is “HHHH:MM” (HHHH expresses the hour by four digits, and MM expresses the minutes by two digits).
Battery replacement flag: A flag that is set to be valid (for example, “1”), when the possible drive time of the communication terminal 5 calculated by the calculation unit 96 based on the reception frequency and the drive time becomes lower than a certain value (for example, 50 hours). When this flag becomes valid, a notification unit 95 described below sends a notification to an administrator who is set in advance.

Furthermore, in the management information F indicated in FIG. 29, in addition to the items indicated in FIG. 28, an item “outdoor flag” is associated with each communication terminal 5 and stored. Contents of the “outdoor flag” are described below.
Outdoor flag: a flag that is set to be valid (for example, “1”), when the position information X received from the communication terminal 5 expresses an outdoor position.

The position information management system 9 includes, in addition to the functions illustrated in FIG. 16, a notification unit 95, a calculation unit 96, and a determining unit 97.

The notification unit 95 is mainly realized by processes by the CPU 901 illustrated in FIG. 12, and issues a notification message indicating that the battery needs to be replaced, to an administrator of the communication terminal 5 whose “battery replacement flag” included in the management information F is valid (for example, “1”). For example, the administrator may be identified by the “owner name (administrator name)” associated with the communication terminal 5, in the management information F. The message notification may be repeatedly sent at arbitrary timings, until the “battery replacement flag” becomes invalid.

For example, the notification message may be issued to the administrator by e-mail. However, the method of issuing the notification message is not limited to this example; for example, the notification message may be issued by an instant message. Furthermore, the information of the notification destination of the administrator may be registered in advance in an address book in the position information management system 9.

The calculation unit 96 is mainly realized by processes by the CPU 901 illustrated in FIG. 12. The calculation unit 96 calculates the “drive time” by using information indicating the known usage start time of starting to use a communication terminal 5 (time when usage is started by using a battery that is unused or fully charged), and information indicating the present time. The usage start time may be set in advance by an administrator. The calculated “drive time” is stored at a corresponding item in the management information F.

The calculation unit 96 may calculate the drive time by using the reception date/time of the newest position information, instead of using the present time. The drive time may be periodically calculated at timings when the position information X is received or at time intervals determined in advance.

Furthermore, the calculation unit 96 calculates the possible drive time of the communication terminal 5, by using the “drive time” calculated as described above, the “reception frequency”, and a known maximum drive time of the communication terminal 5 (that is to say, the time length that operation is possible by using a battery that is unused or fully charged). The possible drive time expresses the time length during which the communication terminal 5 can be driven with the battery capacity at the time point when the drive time is calculated. For example, the possible drive time is calculated by the following method.

Prerequisite: maximum drive time “5000:00” (5000 hours 00 minutes)
The power required for sending the position information corresponds to 10 hours of the above drive time.

possible drive time=maximum drive time−(drive time+10×reception frequency)

Note that the maximum drive time is set in advance by the administrator for each communication terminal 5.

When the calculated possible drive time becomes lower than a certain value (for example, “0050:00” (50 hours 00 minutes), the battery replacement flag in the management information F is set to be valid. The battery replacement flag is set to be invalid (for example, “0”) again according to an instruction by the administrator, when the battery of the communication terminal 5 is replaced or charged.

The determining unit 97 is mainly realized by processes by the CPU 901 illustrated in FIG. 12, and determines whether the position information of the communication terminal 5 received by the sending/receiving unit 91 expresses an outdoor location. For example, it can be determined whether the position information expresses an outdoor location, depending on whether the position information sent from the communication terminal 5 includes information of a “floor number” or a “building”.

When the position information expresses an outdoor position or a boundary between indoors and outdoors (for example, a known position of the transmission device 3 installed at the entrance of the building), the determining unit 97 sets the “outdoor flag” in the management information F as valid (for example, “1”). Then, when position information expressing an indoor position is received from the communication terminal 5, the determining unit 97 sets the “outdoor flag” as invalid (for example, “0”). The determining unit 97 may use a table (not shown) that is prepared in advance, in which the position information, an outdoor position, or a boundary between indoors and outdoors, are associated with each other, in order to determine whether the position information expresses an outdoor position or a boundary between indoors and outdoors.

The “outdoor flag” is used by an application using the position information stored in the position information management system 9. For example, a communication terminal 5 whose “outdoor flag” is set to be valid cannot acquire position information of indoors until the “outdoor flag” is set to be invalid again. An application, which mainly uses position information for indoors, recognizes that information is not updated for a communication terminal 5 whose “outdoor flag” is valid, and can perform an appropriate process.

Note that when the position information expresses an outdoor position or a boundary between indoors and outdoors, the determining unit 97 may set the “outdoor flag” in the management information F based on outdoor flag information (for example, information including an “outdoor” field) sent from the communication terminal 5. In this case, the communication terminal 5 needs to determine by itself as to whether the position information is expressing an outdoor position or a boundary between indoors and outdoors.

For making this determination, for example, when the position information is obtained by GPS positioning, the communication terminal 5 may determine that the position information is expressing outdoors. Furthermore, when information including a special flag (for example, an IMES frame in which the “boundary” field is set to “1”) is received together with the position information from the transmission device 3 installed at the entrance at a boundary between indoors and outdoors, the communication terminal 5 may determine that the position information is expressing a boundary between indoors and outdoors.

In this case, for example, the communication terminal 5 sends, to the position information management system 9 via the transmission device 3, outdoor flag information in which the “outdoor” field is set to “1”, together with position information. Furthermore, for example, when the communication terminal 5 receives position information of an indoor position, the communication terminal 5 sends, to the position information management system 9 via the transmission device 3, outdoor flag information in which the “outdoor” field is set to “0”, together with position information.

Note that as described above, the sending/receiving unit 91 in the position information management system 9 according to the present embodiment may not only receive position information X transmitted by the transmission device 3 and sent by the communication terminal 5, but may also receive position information sent from an outdoor GPS satellite.

By the above process, the administrator of the communication terminal 5 can recognize when to replace or to charge the battery.

### Operations

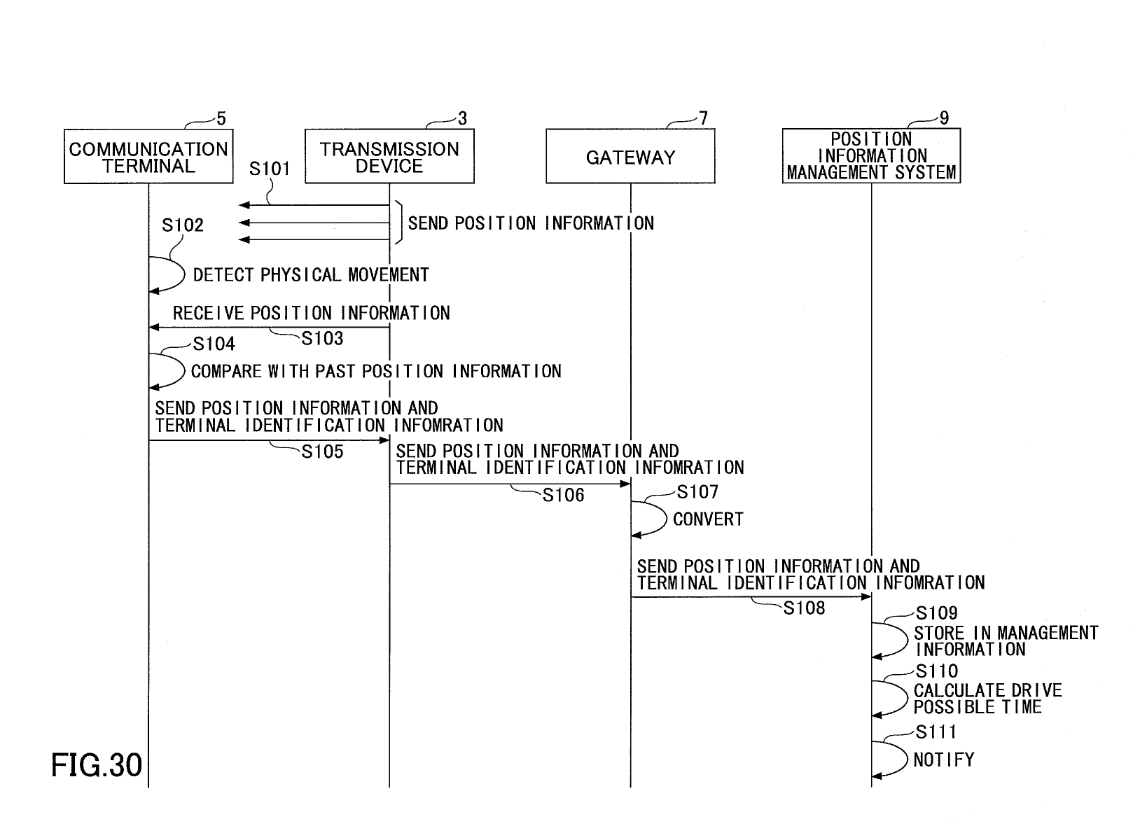

Next, with reference to FIGS. 30 through 32, a description is given of operations of the position management system 1 according to an embodiment of the present invention.

First, FIG. 30 illustrates an example of operations of the entire position management system 1 according to an embodiment of the present invention.

In step S101, the transmission unit 21 of the transmission device 3 transmits position information.

In step S102, the movement detecting unit 45 in the communication terminal 5 detects the physical movement of the communication terminal 5, based on the change in the acceleration detected by the detecting unit 42. At this time, the position information X stored in the storage unit 49 at the present time point is stored as position information X₀.

In step S103, the receiving unit 41 in the communication terminal 5 receives position information X from the transmission device 3. The position information X is stored in the storage unit 49.

In step S104, the movement detecting unit 45 in the communication terminal 5 compares the position information X received in step S103 with the past position information X₀.

In step S105, when the position information X and the position information X₀ are different, the sending/receiving unit 51 in the communication terminal 5 sends the position information X and the terminal identification information A to the transmission device 3.

In step S106, the sending/receiving unit 31 in the transmission device 3 sends the position information X and the terminal identification information A received from the communication terminal 5, to the gateway 7.

In step S107, the conversion unit 82 in the gateway 7 converts the format of the data including the position information X and the terminal identification information A received from the transmission device 3, into a format by which packet communication is possible.

In step S108, the sending/receiving unit 81 in the gateway 7 sends the converted position information X and the terminal identification information A to the position information management system 9.

In step S109, the storage unit 99 in the position information management system 9 stores the received position information X in association with the communication terminal 5 identified by the terminal identification information A in the management information F.

In step S110, the calculation unit 96 in the position information management system 9 calculates the possible drive time of the communication terminal 5, by using the “drive time” of the communication terminal 5 at the present time point, the “reception frequency” of the position information, and the known maximum drive time of the communication terminal 5.

In step S111, a message indicating that the battery needs to be replaced is notified by, for example, e-mail, to an administrator of a communication terminal 5 whose possible drive time calculated at step S110 is below a certain value.

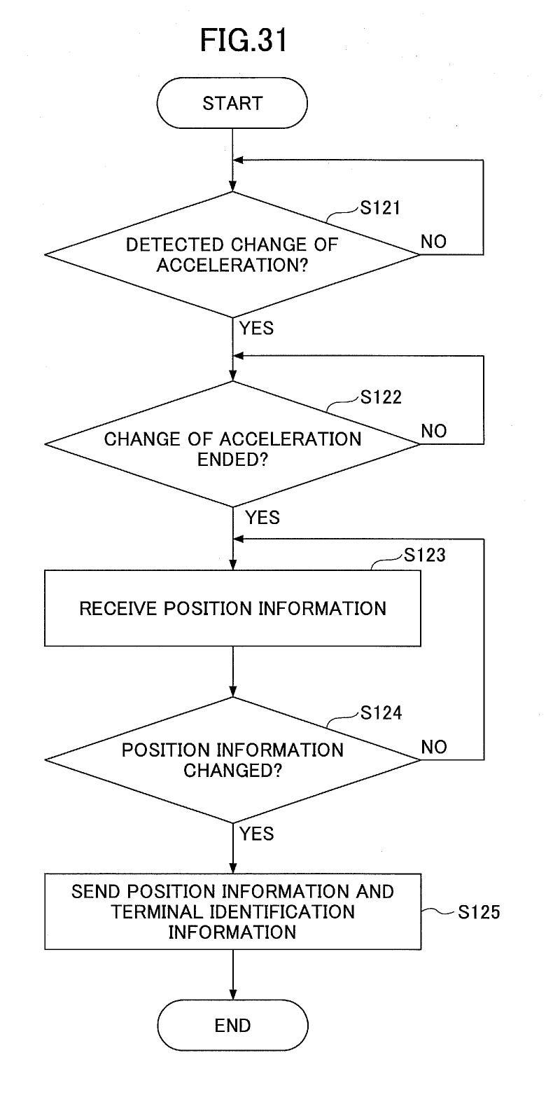

FIG. 31 is a flowchart giving a detailed description of the process of steps S102 through S105 of FIG. 30 executed by the communication terminal 5.

In step S121, when the detecting unit 42 detects a change in the acceleration, the process proceeds to step S122. When this is not detected, step S121 is executed again.

In step S122, when the detecting unit 42 detects that the detected change of acceleration has ended (for example, when a predetermined time elapses after the change in the acceleration cannot be detected any more), the process proceeds to step S123. When this is not detected, step S122 is executed again.

In step S123, the receiving unit 41 receives position information X transmitted from the transmission device 3. At this time, the position information X that has been received before is stored as past position information X₀.

In step S124, the movement detecting unit 45 compares the position information X received in step S123 with the past position information X₀. When the position information X and the position information X₀ are different (that is to say, when the position information has changed), the process proceeds to step S125. When the position information X and the position information X₀ are not different, the process returns to step S123.

In step S125, the sending/receiving unit 51 sends the position information X and terminal identification information A to the transmission device 3.

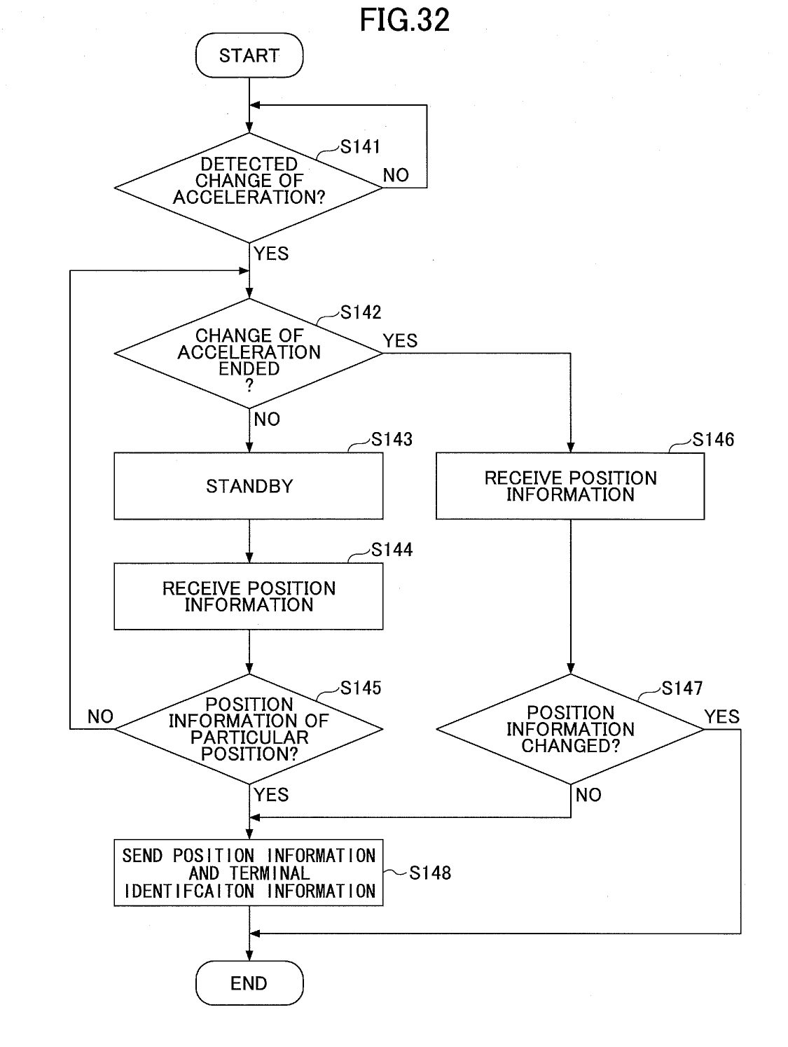

Next, FIG. 32 is a flowchart expressing operations in a case where the communication terminal 5 receives position information of a known, particular position.

In step S141, when the detecting unit 42 detects a change in the acceleration, the process proceeds to step S142. When this is not detected, step S141 is executed again.

In step S142, when the detecting unit 42 detects that the detected change in the acceleration has ended, the process proceeds to step S146, and the position information X and terminal identification information A are sent to the transmission device 3, similar to steps S123 through S125 in FIG. 31 (steps S147, S148).

Meanwhile, in step S142, when the detecting unit 42 does not detect that the detected change in the acceleration has ended (that is to say, the communication terminal 5 is moving), the process proceeds to step S143.

In step S143, the receiving unit 41 stands by for a predetermined time amount, and in step S144, the receiving unit 41 receives the position information X sent from the transmission device 3.

In step S145, when the position information received at step S144 is position information expressing a known, particular position, the process proceeds to step S148, and the position information and the terminal identification information A received at step S144 are sent to the transmission device 3.

Meanwhile, when the position information received at step S144 is not position information expressing a known, particular position, the process returns to step S142.

By the above process, the communication terminal 5 in the position management system 1 according to an embodiment of the present invention can send position information to the position information management system 9 when the position has changed due to physical movement. Accordingly, when the position does not change, communication is not performed, and therefore power consumption according to a useless operation of sending position information can be suppressed. Meanwhile, the communication terminal 5 may be configured to send position information, when the communication terminal 5 has passed a position which the user wants to clearly recognize that the communication terminal 5 has passed, such as the entrance of a building.

Note that in step S146 of FIG. 32, when the received position information is position information of outdoors (that is to say, position information acquired form positioning signals sent form a GPS satellite), the corresponding position information may not be sent to the position information management system 9.

Furthermore, step S143 in FIG. 32 is arbitrary; the receiving unit 41 may not stand by for a predetermined time amount.

According to one embodiment of the present invention, a communication terminal, a position management system, and a communication method are provided, which are capable of reducing the power consumption of a communication terminal which transmits position information in a position management system.

The communication terminal, the position management system, and the communication method are not limited to the specific embodiments described herein, and variations and modifications may be made without departing from the scope of the present invention.

The present application is based on and claims the benefit of priority of Japanese Priority Patent Application No. 2013-001158, filed on Jan. 8, 2013, the entire contents of which are hereby incorporated herein by reference.

What is claimed is:

1. A communication terminal comprising:
a receiving unit configured to receive position information that has been transmitted from a transmission device for transmitting predetermined position information;
a detecting unit configured to detect a change in an acceleration applied to the communication terminal;
a movement detecting unit configured to detect a movement of the communication terminal based on the position information and information expressing the change in the acceleration; and
a sending unit configured to send the position information to the transmission device, when the movement is detected.

2. The communication terminal according to claim 1, wherein
the movement detecting unit detects the movement of the communication terminal, when position information newly received by the receiving unit after the detecting unit detects the change in the acceleration, is different from position information acquired before the detecting unit detects the change in the acceleration.

3. The communication terminal according to claim 1, wherein
the sending unit sends the position information to the transmission device, when position information newly received by the receiving unit after the detecting unit detects the change in the acceleration, is position information expressing a predetermined position.

4. The communication terminal according to claim 1, wherein
the sending unit sends the position information received by the receiving unit, when the communication terminal is activated.

5. The communication terminal according to claim 1, wherein
the receiving unit further receives a positioning signal sent from a GPS satellite, and
the sending unit does not send, to the transmission device, position information obtained based on the positioning signal.

6. A position management system comprising:
a communication terminal; and
a position information management system, wherein
the communication terminal includes
a receiving unit configured to receive position information that has been transmitted from a transmission device for transmitting predetermined position information,
a detecting unit configured to detect a change in an acceleration of the communication terminal,
a movement detecting unit configured to detect a movement of the communication terminal based on the position information and information expressing the change in the acceleration, and
a sending unit configured to send the position information to the transmission device, when the movement is detected, wherein
the position information management system is configured to communicate with the communication terminal via a gateway, and to manage the position information sent from the sending unit of the communication terminal.

7. The position management system according to claim 6, wherein
the position information management system calculates a possible drive time of the communication terminal by using information expressing a frequency of receiving the position information.

8. The position management system according to claim 7, wherein
the position information management system issues a notification message to an administrator of the communication terminal, when the possible drive time becomes less than or equal to a predetermined value.

9. A communication method executed by a communication terminal, the communication method comprising:
receiving position information that has been transmitted from a transmission device for transmitting predetermined position information;
detecting a change in an acceleration applied to the communication terminal;
detecting a movement of the communication terminal based on the position information and information expressing the change in the acceleration; and
sending the position information to the transmission device, when the movement is detected.
